(19) United States
(12) Patent Application Publication
(10) Pub. No.: US 2023/0127705 A1
(43) Pub. Date: Apr. 27, 2023

(54) LINK FAILURE MONITORING AT A MULTI-SIM DEVICE IN A WIRELESS NETWORK

(71) Applicant: QUALCOMM Incorporated, San Diego, CA (US)

(72) Inventors: Ozcan OZTURK, San Diego, CA (US); Arvind Vardarajan SANTHANAM, San Diego, CA (US); Reza SHAHIDI, La Jolla, CA (US); Carlos CABRERA MERCADER, Cardiff, CA (US)

(21) Appl. No.: 17/969,532

(22) Filed: Oct. 19, 2022

Related U.S. Application Data
(60) Provisional application No. 63/270,451, filed on Oct. 21, 2021.

(51) Int. Cl. H04W 76/19; H04W 36/30; H04W 24/08

(52) U.S. Cl. CPC H04W 76/19; H04W 36/305; H04W 24/08; H04W 88/06

(57) ABSTRACT

A multi-SIM user equipment (UE) can perform link failure operations associated with a first universal subscriber identity module (USIM) in an active state during a time gap when the UE can perform a network operation on a second USIM in a non-active state. The UE can monitor a failure event associated with the first USIM using a first procedure. The failure event includes a radio link failure, a beam failure, and/or a listen-before-talk (LBT) failure. The UE can transmit a request to a network entity for a time gap to perform a network operation associated with the second USIM, while the first USIM remains in a radio resource control (RRC) connected state during the time gap. The UE can monitor, using a second procedure during the time gap, the failure event associated with the first USIM.

### PRIORITY CLAIM

This application claims priority to and the benefit of provisional patent application No. 63/270,451 filed in the United States Patent Office on Oct. 21, 2021, the entire content of which is incorporated herein by reference as if fully set forth below in its entirety and for all applicable purposes.

### TECHNICAL FIELD

The technology discussed below relates generally to wireless communication systems, and more particularly, to link failure monitoring at a multi-SIM wireless communication device.

### INTRODUCTION

Fifth Generation (5G) New Radio (NR) networks may deploy cells that utilize one or more frequency bands or carriers (e.g., a millimeter wave (e.g., FR2) carrier or a sub-6 GHz (e.g., FR1) carrier) to facilitate communication between a network entity and a user equipment (UE). In some wireless communication networks, a UE may be configured to simultaneously communicate on multiple carriers. For example, a UE may be configured to operate using one or more universal subscriber identity modules (USIMs), allowing the UE to connect to multiple networks, or have multiple independent connections (e.g., one connection per USIM) to the same network. A UE equipped with multiple USIMs can be referred to as multi-SIM UE or device. A multi-SIM UE can use a first USIM to actively communicate with a first network associated with the first USIM, and perform idle and/or inactive mode activities (e.g., monitoring for paging messages, idle mode measurements, etc.) with a second network associated with a non-active USIM.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

A multi-SIM (MUSIM) user equipment (UE) can continue radio link monitoring (RLM) and/or beam failure detection (BFD) operations associated with a first universal subscriber identity module (USIM) in an active state during a time gap (e.g., MUSIM time gap) in which the multi-SIM UE can perform a network operation using a second USIM that is in a non-active state. The UE can monitor a failure event associated with the first USIM. For example, the failure event can include at least one of a radio link failure (RLF), a beam failure, or a listen-before-talk (LBT) failure. The UE can perform the network operation associated with the second USIM in a non-active state, while the first USIM remains in an active state (e.g., a radio resource control (RRC) connected state) during the time gap.

One aspect of the disclosure provides a user equipment (UE) for wireless communication. The UE includes a transceiver, a memory, a first universal subscriber identity module (USIM), a second USIM, and a processor. The processor is coupled to the first USIM, the second USIM, the transceiver, and the memory. The processor and the memory are configured to monitor, using a first procedure, a failure event associated with the first USIM, the failure event comprising at least one of a radio link failure, a beam failure, or a listen-before-talk (LBT) failure. The processor and the memory are further configured to transmit, to a network entity, a request for a time gap to perform a network operation associated with the second USIM, while the first USIM remains in a radio resource control (RRC) connected state during the time gap. The processor and the memory are further configured to monitor, using a second procedure during the time gap, the failure event associated with the first USIM.

One aspect of the disclosure provides a method of wireless communication at a user equipment (UE). The method includes monitoring, using a first procedure, a failure event associated with a first universal subscriber identity module (USIM) of the UE, the failure event comprising at least one of a radio link failure, a beam failure, or a listen-before-talk (LBT) failure. The method further includes transmitting, to a network entity, a request for a time gap to perform a network operation associated with a second USIM of the UE, while the first USIM remains in a radio resource control (RRC) connected state during the time gap. The method further includes monitoring, using a second procedure during the time gap, the failure event associated with the first USIM.

One aspect of the disclosure provides a user equipment (UE) for wireless communication. The UE includes means for monitoring, using a first procedure, a failure event associated with a first universal subscriber identity module (USIM) of the UE, the failure event comprising at least one of a radio link failure, a beam failure, or a listen-before-talk (LBT) failure. The UE further includes means for transmitting, to a network entity, a request for a time gap to perform a network operation associated with a second USIM of the UE, while the first USIM remains in a radio resource control (RRC) connected state during the time gap. The UE further includes means for monitoring, using a second procedure during the time gap, the failure event associated with the first USIM.

One aspect of the disclosure provides a computer-readable storage medium stored with executable codes for wireless communication. The executable codes include instructions that cause a user equipment (UE) to monitor, using a first procedure, a failure event associated with a first universal subscriber identity module (USIM) of the UE, the failure event comprising at least one of a radio link failure, a beam failure, or a listen-before-talk (LBT) failure. The instructions further cause the UE to transmit, to a network entity, a request for a time gap to perform a network operation associated with a second USIM of the UE, while the first USIM remains in a radio resource control (RRC) connected state during the time gap. The instructions further cause the UE to monitor, using a second procedure during the time gap, the failure event associated with the first USIM.

One aspect of the disclosure provides a user equipment (UE) in a wireless communication network. The UE includes a memory, a first universal subscriber identity module (USIM), a second USIM, and a processor coupled to the first USIM, the second USIM, and the memory. The processor is configured to monitor, using a first procedure, a failure event associated with the first USIM, the failure event comprising at least one of a radio link failure (RLF), a beam failure, or a listen-before-talk (LBT) failure. The processor is further configured to transmit, to a network entity, a request for a time gap to perform a network operation associated with the second USIM, while the UE remains in a radio resource control (RRC) connected state associated with the first USIM during the time gap. The processor is further configured to monitor, during the time gap, the failure event associated with the first USIM, using a second procedure different than the first procedure.

One aspect of the disclosure provides a method of wireless communication at a user equipment (UE). The method includes monitoring, using a first procedure, a failure event associated with a first universal subscriber identity module (USIM) of the UE, the failure event comprising at least one of a radio link failure (RLF), a beam failure, or a listen-before-talk (LBT) failure. The method further includes transmitting, to a network entity, a request for a time gap to perform a network operation associated with a second USIM of the UE, while the UE remains in a radio resource control (RRC) connected state associated with the first USIM during the time gap. The method further includes monitoring, using a second procedure during the time gap, the failure event associated with the first USIM, the first procedure and the second procedure being different in techniques used for monitoring to at least one of the RLF, the beam failure, or the LBT failure.

One aspect of the disclosure provides a user equipment (UE) for wireless communication. The UE includes means for monitoring, using a first procedure, a failure event associated with a first universal subscriber identity module (USIM) of the UE, the failure event comprising at least one of a radio link failure (RLF), a beam failure, or a listen-before-talk (LBT) failure. The UE further includes means for transmitting, to a network entity, a request for a time gap to perform a network operation associated with a second USIM of the UE, while the UE remains in a radio resource control (RRC) connected state associated with the first USIM during the time gap. The UE further includes means for monitoring, during the time gap, the failure event associated with the first USIM, using a second procedure different than the first procedure.

One aspect of the disclosure provides a computer-readable storage medium stored with executable codes for wireless communication. The executable codes include instructions that cause a user equipment (UE) to monitor, using a first procedure, a failure event associated with a first universal subscriber identity module (USIM) of the UE, the failure event comprising at least one of a radio link failure (RLF), a beam failure, or a listen-before-talk (LBT) failure. The executable codes further include instructions that cause the UE to transmit, to a network entity, a request for a time gap to perform a network operation associated with a second USIM of the UE, while the UE remains in a radio resource control (RRC) connected state associated with the first USIM during the time gap. The executable codes further include instructions that cause the UE to monitor, during the time gap, the failure event associated with the first USIM, using a second procedure different than the first procedure.

These and other aspects of the invention will become more fully understood upon a review of the detailed description, which follows. Other aspects, features, and implementations will become apparent to those of ordinary skill in the art, upon reviewing the following description of specific, exemplary implementations in conjunction with the accompanying figures. While features may be discussed relative to certain examples and figures below, all implementations can include one or more of the advantageous features discussed herein. In other words, while one or more implementations may be discussed as having certain advantageous features, one or more of such features may also be used in accordance with the various examples discussed herein. In similar fashion, while exemplary implementations may be discussed below as device, system, or method examples, it should be understood that such examples can be implemented in various devices, systems, and methods.

### BRIEF DESCRIPTION OF THE DRAWINGS

FIG. 1 is a schematic illustration of a wireless communication system according to some aspects.

FIG. 2 is a schematic illustration of an exemplary radio access network according to some aspects.

FIG. 3 is a diagram illustrating an example of a disaggregated base station architecture according to some aspects.

FIG. 4 is a schematic illustration of an organization of wireless resources in an air interface utilizing orthogonal frequency divisional multiplexing (OFDM) according to some aspects.

FIG. 5 is a diagram illustrating a multi-cell transmission environment according to some aspects.

FIG. 6 is a diagram illustrating a multi-RAT deployment environment according to some aspects.

FIG. 7 is a block diagram illustrating an example of various components of a 5G wireless communication system according to some aspects.

FIG. 8 is a diagram illustrating an example of 5G state transitions according to some aspects.

FIG. 9 is a diagram illustrating a multi-subscriber identity module card (MSIM) wireless communication device according to some aspects.

FIG. 10 is a diagram illustrating communication between a network entity and a scheduled entity using beamformed signals according to some aspects.

FIG. 11 is a diagram illustrating a MSIM wireless communication device using a time gap created with an active universal subscriber identity module (USIM) for performing network activities on a non-active SIM according to some aspects.

FIG. 12 is a flow chart illustrating a procedure for monitoring beam failure using a time gap at a MSIM wireless communication device according to some aspects.

FIG. 13 is a flow chart illustrating a procedure for monitoring radio link failure (RLF) using a time gap at a MSIM wireless communication device according to some aspects.

FIG. 14 a flow chart illustrating a procedure for monitoring listen-before-talk (LBT) failure using a time gap at a MSIM wireless communication device according to some aspects.

FIG. 15 is a flow chart illustrating a procedure for suspending or stopping radio link monitoring and beam failure detection operations during a time gap on an active USIM at a MSIM wireless communication device according to some aspects.

FIG. 16 is a flow chart illustrating a procedure for performing radio link monitoring (RLM) and beam failure detection (BFD) operations during a time gap on an active USIM at a MSIM wireless communication device according to some aspects.

FIG. 17 is a flow chart illustrating a procedure for terminating a time gap on an active USIM at a MSIM wireless communication device according to some aspects.

FIG. 18 is a block diagram conceptually illustrating an example of a hardware implementation for a scheduled entity according to some aspects.

FIG. 19 is a flow chart illustrating an exemplary process for monitoring link failure at a MSIM wireless communication device according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

Aspects of the disclosure provide a user equipment (UE) with multiple universal subscriber identity modules (USIMs) that can perform link failure monitoring (LFM) and/or beam failure detection (BFD) operations associated with a first USIM in an active state during a time gap when the UE can perform a network operation on a second USIM that is in a non-active state. For example, the failure event can include at least one of a radio link failure, a beam failure, or a listen-before-talk (LBT) failure. The UE can perform the network operation associated with the second USIM, while the UE remains in a radio resource control (RRC) connected state with a network associated with the first USIM during the time gap. In some aspects, the UE may re-tune its radio frequency (RF) circuitry (if needed) during the time gap when switching between the first USIM and second USIM. In some aspects, the time gap may be referred to as a MUSIM gap.

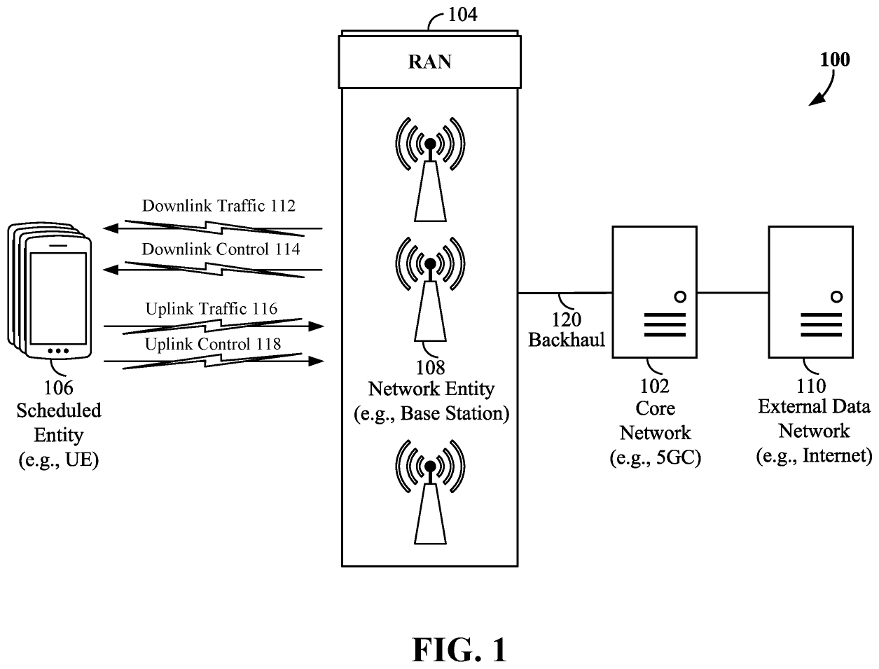

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of network entities 108 (e.g., base stations. Broadly, a base station is a network element in a radio access network responsible for radio transmission and reception in one or more cells to or from a UE. In different technologies, standards, or contexts, a network entity (e.g., a base station) may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, radio frequency (RF) chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a network entity (e.g., base station 108) to one or more UEs (e.g., UE 106) may be referred to as downlink (DL) transmission. In accordance with certain aspects of the present disclosure, the term downlink may refer to a point-to-multipoint transmission originating at a network entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a network entity (e.g., a base station 108) allocates resources for communication among some or all devices and equipment within its service area or cell. Within the present disclosure, as discussed further below, the network entity may be responsible for scheduling, assigning, reconfiguring, and releasing resources for one or more scheduled entities. That is, for scheduled communication, UEs 106, which may be scheduled entities, may utilize resources allocated by the network entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a network entity (e.g., base station 108) may broadcast downlink traffic 112 to one or more scheduled entities 106. Broadly, the network entity 108 is a node or device responsible for scheduling traffic in a wireless communication network, including the downlink traffic 112 and, in some examples, uplink traffic 116 from one or more scheduled entities 106 to the network entity 108. On the other hand, the scheduled entity 106 is a node or device that receives downlink control information 114, including but not limited to scheduling information (e.g., a grant), synchronization or timing information, or other control information from another entity in the wireless communication network such as the network entity 108. The scheduled entity 106 may further transmit uplink control information 118, including but not limited to a scheduling request or feedback information, or other control information to the network entity 108. In some aspects, the scheduled entity 106 (e.g., UE) may be a multi-SIM device that can use one or more USIMs to communicate with one or more networks.

In addition, the uplink and/or downlink control information 114 and/or 118 and/or traffic information 112 and/or 116 may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, network entities (e.g., base stations 108) may include a backhaul interface for communication with a backhaul portion 120 of the wireless communication system. The backhaul 120 may provide a link between a base station 108 and the core network 102. Further, in some examples, a backhaul network may provide interconnection between the respective network entities (e.g., base stations 108). Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

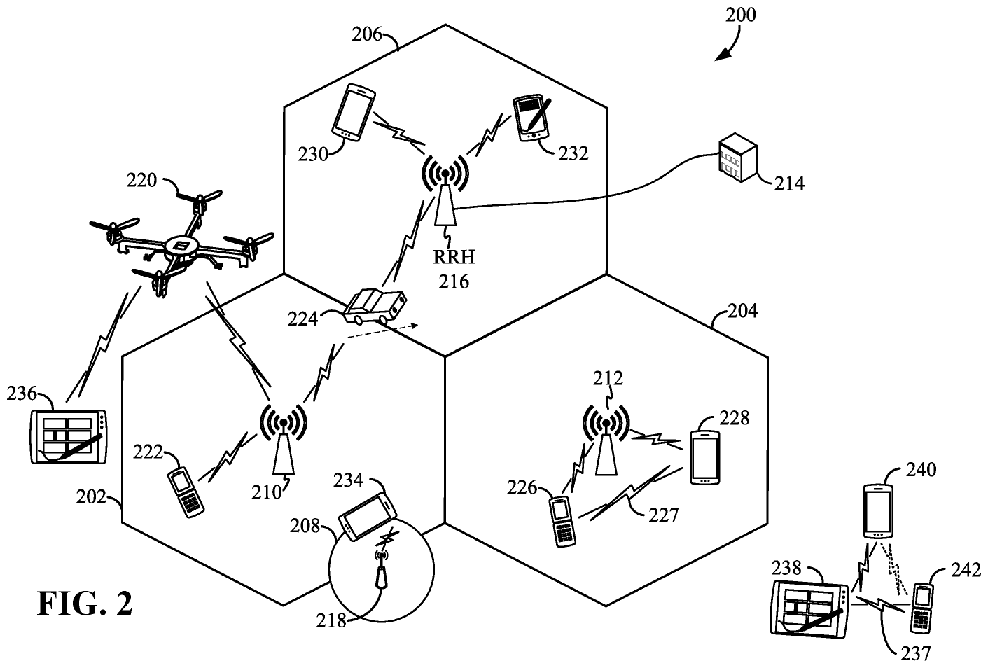

Referring now to FIG. 2, by way of example and without limitation, a schematic illustration of a RAN 200 is provided. In some examples, the RAN 200 may be the same as the RAN 104 described above and illustrated in FIG. 1. The geographic area covered by the RAN 200 may be divided into cellular regions (cells) that can be uniquely identified by a UE based on an identification broadcasted from one access point or network entity (e.g., a base station). FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/network entity 108 described above and illustrated in FIG. 1.

FIG. 2 further includes an unmanned aerial vehicle (UAV) 220, which may be a quadcopter or drone. The UAV 220 may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1.

In some examples, the UAV 220 (e.g., quadcopter) may be configured to function as a UE. For example, the UAV 220 may operate within cell 202 by communicating with base station 210.

In a further aspect of the RAN 200, sidelink signals may be used between UEs without necessarily relying on scheduling or control information from a base station. For example, two or more UEs (e.g., UEs 238, 240, and 242) may communicate with each other using peer to peer (P2P) or sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication. In either case, such sidelink signaling 227 and 237 may be implemented in a P2P network, a device-to-device (D2D) network, vehicle-to-vehicle (V2V) network, a vehicle-to-everything (V2X), a mesh network, or other suitable direct link network.

In the radio access network 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) and a security anchor function (SEAF) that perform authentication. The SCMF can manage, in whole or in part, the security context for both the control plane and the user plane functionality.

In various aspects of the disclosure, a radio access network 200 may utilize DL-based mobility or UL-based mobility to enable mobility and handovers (i.e., the transfer of a UE's connection from one radio channel to another). In a network configured for DL-based mobility, during a call with a network entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the radio access network 200. Each of the cells may measure a strength of the pilot signal, and the radio access network (e.g., one or more of the base stations 210 and 214/216 and/or a central node within the core network) may determine a serving cell for the UE 224. As the UE 224 moves through the radio access network 200, the network may continue to monitor the uplink pilot signal transmitted by the UE 224. When the signal strength or quality of the pilot signal measured by a neighboring cell exceeds that of the signal strength or quality measured by the serving cell, the network 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The air interface in the radio access network 200 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

Further, the air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS), or one or more units (or one or more components) performing base station functionality, may be implemented in an aggregated or disaggregated architecture. For example, a BS (such as a NB, eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

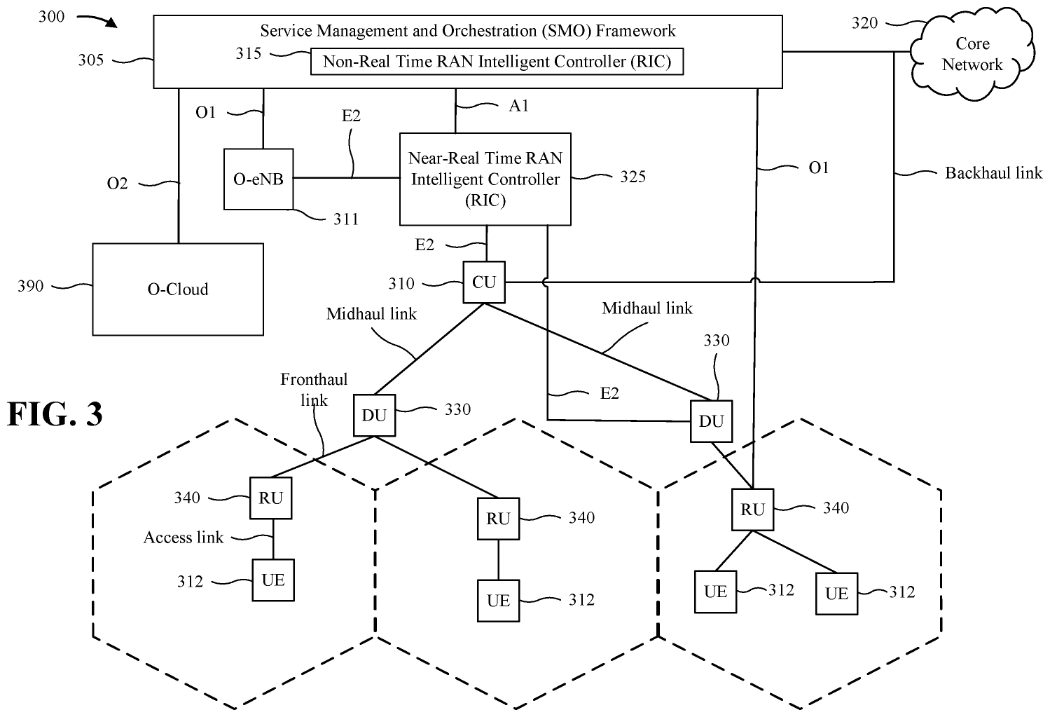

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 312 via one or more radio frequency (RF) access links. In some implementations, the UE 312 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 312. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

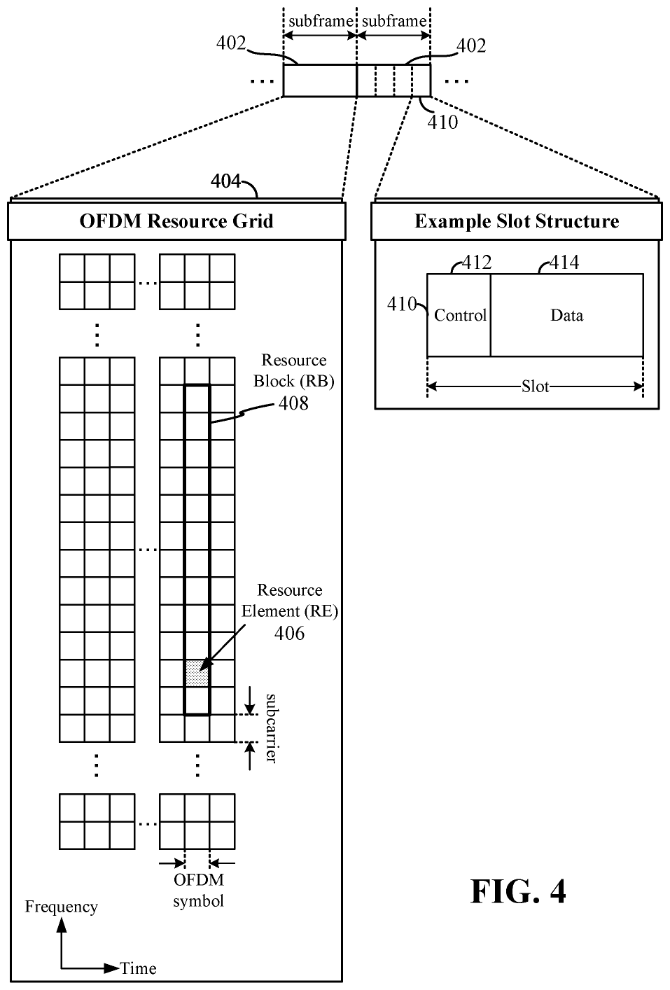

Various aspects of the present disclosure will be described with reference to an OFDM waveform, schematically illustrated in FIG. 4. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 4, an expanded view of an exemplary subframe 402 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. That is, in a multiple-input-multiple-output (MIMO) implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a network entity, such as a base station (e.g., gNB, eNB, etc.), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely exemplary in nature, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the network entity (e.g., a base station) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The network entity may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A network entity (e.g., base station, gNB, CU/DU) may transmit other system information (OSI) as well.

In an UL transmission, the scheduled entity (e.g., UE) may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

The physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIGS. 1-4 are not necessarily all of the channels or carriers that may be utilized between devices, and those of ordinary skill in the art will recognize that other channels or carriers may be utilized in addition to those illustrated, such as other traffic, control, and feedback channels.

Wireless communication networks, such as 4G LTE and/or 5G NR networks, may further support carrier aggregation in a multi-cell transmission environment where, for example, different base stations and/or different transmission and reception points (TRPs) may communicate on different component carriers within overlapping cells. In some aspects, the term component carrier (CC) may refer to a carrier frequency (or band) utilized for communication within a cell.

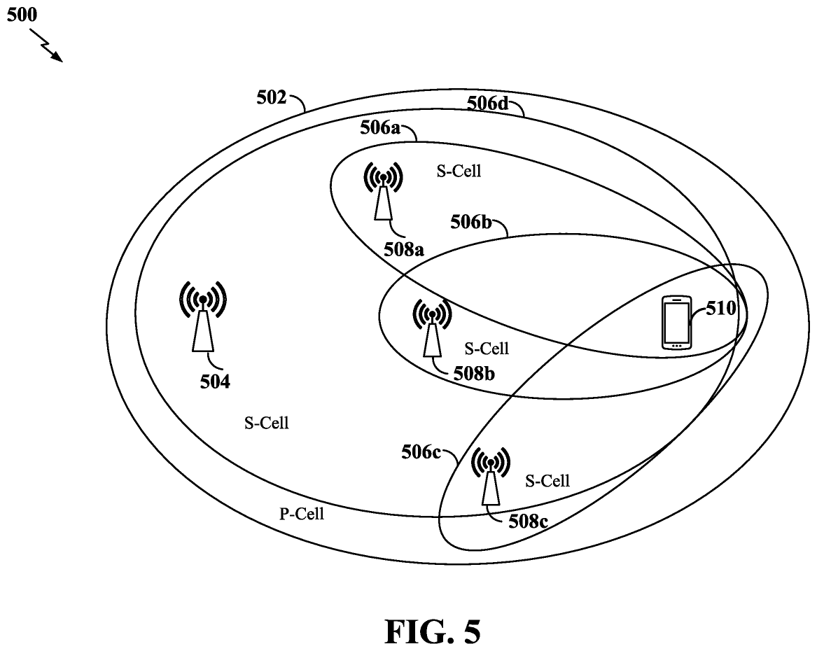

FIG. 5 is a diagram illustrating a multi-cell transmission environment 500 according to some aspects. The multi-cell transmission environment 500 includes a primary serving cell (PCell) 502 and one or more secondary serving cells (SCells) 506a, 506b, 506c, and 506d. The PCell 502 may be referred to as the anchor cell that provides a radio resource control (RRC) connection to a UE (e.g., UE 510). In some aspects, the UE may be a multi-SIM device that includes multiple USIMs.

When carrier aggregation is configured in the multi-cell transmission environment 500, one or more of the SCells 506a-506d may be activated or added to the PCell 502 to form the serving cells serving the UE 510. In this case, each of the serving cells corresponds to a component carrier (CC). The CC of the PCell 502 may be referred to as a primary CC, and the CC of a SCell 506a-506d may be referred to as a secondary CC.

Each of the PCell 502 and the SCells 506a-506d may be served by a network entity (e.g., a transmission and reception point (TRP), RU). For example, the PCell 502 may be served by TRP 504 and each of the SCells 506a-506c may be served by a respective TRP 508a-508c. Each TRP 504 and 508a-508c may be a base station (e.g., gNB), remote radio head (RRH) of a gNB, or other scheduling entity similar to those illustrated in any of FIGS. 1-3. In some examples, the PCell 502 and one or more of the SCells (e.g., SCell 506d) may be co-located. For example, a TRP for the PCell 502 and a TRP for the SCell 506d may be installed at the same geographic location. Thus, in some examples, a TRP (e.g., TRP 504) may include multiple TRPs or RUs, each corresponding to one of a plurality of co-located antenna arrays, and each supporting a different carrier (different CC). However, the coverage of the PCell 502 and SCell 506d may differ since component carriers in different frequency bands may experience different path loss, and thus provide different coverage.

The PCell 502 is responsible not only for connection setup, but also for radio resource management (RRM) and radio link monitoring (RLM) of the connection with the UE 510. For example, the PCell 502 may activate one or more of the SCells (e.g., SCell 406a) for multi-cell communication with the UE 510 to improve the reliability of the connection to the UE 510 and/or to increase the data rate. In some examples, the PCell may activate the SCell 506a on an as-needed basis instead of maintaining the SCell activation when the SCell 506a is not utilized for data transmission/reception in order to reduce power consumption by the UE 510.

In some examples, the PCell 502 may be a low band cell, and the SCells 506 may be high band cells. A low band (LB) cell uses a CC in a frequency band lower than that of the high band cells. For example, the high band cells may each use a respective mmWave CC (e.g., FR2 or higher), and the low band cell may use a CC in a lower frequency band (e.g., sub-6 GHz band or FR1). In general, a cell using an FR2 or higher CC can provide greater bandwidth than a cell using an FR1 CC. In addition, when using above-6 GHz frequency (e.g., mmWave) carriers, beamforming may be used to transmit and receive signals.

In some examples, the PCell 502 may utilize a first radio access technology (RAT), such as LTE, while one or more of the SCells 506 may utilize a second RAT, such as 5G-NR. In this example, the multi-cell transmission environment may be referred to as a multi-RAT-dual connectivity (MR-DC) environment. One example of MR-DC is an Evolved-Universal Terrestrial Radio Access Network-New Radio dual connectivity (EN-DC) mode that enables a UE to simultaneously connect to an LTE TRP and an NR TRP to receive data packets from and send data packets to both the LTE TRP and the NR TRP.

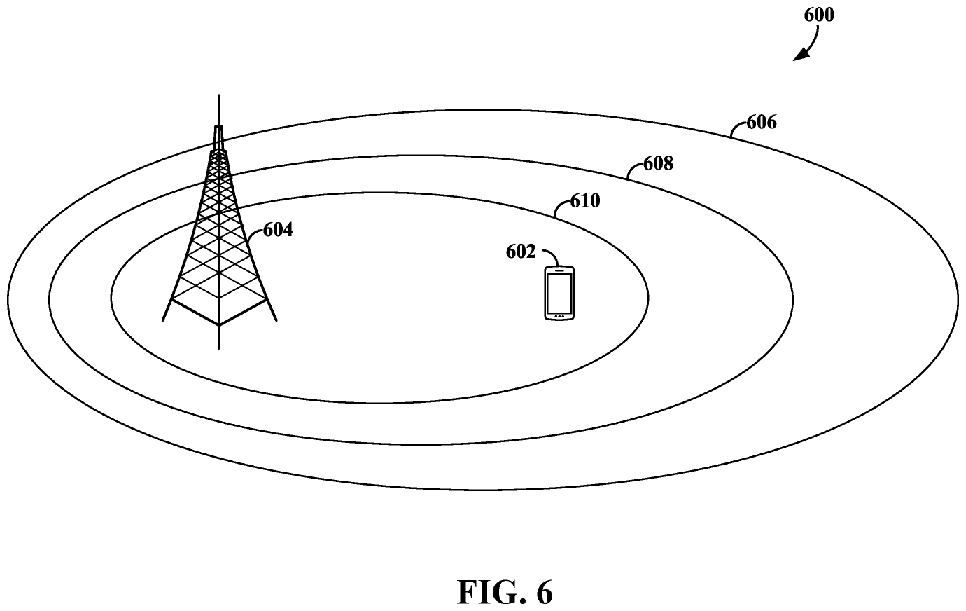

FIG. 6 is a diagram illustrating a multi-RAT deployment environment 600 according to some aspects. In the multi-RAT deployment environment 600 shown in FIG. 6, a UE 602 may communicate with one or more network entities (e.g., a CU/DU, RU, a base station 604) using one or more of a plurality of RATs. For example, the base station 604 may include a plurality of co-located TRPs, each serving a respective cell 606, 608, and 610. In some aspects, the respective cells may be partially or completely overlapped in their coverage areas. Each cell (e.g., cells 606, 608, and 610) may communicate with the UE 602 using a respective RAT and corresponding frequency range or band. In some examples, the RATs may include LTE and NR. For example, a first cell 606 may be an LTE cell that operates in an LTE frequency range to provide wide area coverage to the UE 602. For example, the LTE frequency range may include one or more E-UTRA frequency bands between 450 MHz and 3.8 GHz. In addition, a second cell 608 may be an NR cell that operates in a sub-6 GHz frequency range (e.g., FR1), and a third cell 610 may be an NR cell that operates in a mmWave frequency range (e.g., FR2 or higher). In other aspects, the cells 606, 608, and 610 may use other combinations of LTE and NR frequencies.

In some examples, the UE 602 may communicate with the base station 604 over two or more of the cells 606, 608, and 610 in a MR-DC mode, such as EN-DC, as described above. In some aspects, the UE 602 may be a multi-SIM device that includes two or more USIM cards, each associated with a respective subscription and respective phone number. In some aspects, each USIM may be implemented as a physical USIM or an embedded SIM (eSIM). In one example, the UE 602 may operate under a dual-SIM dual-standby (DSDS) operational mode. In another example, the UE 602 may operate under a dual-SIM dual-active (DSDA) mode. In a further example, UE 602 may include a first USIM having a dedicated data subscription (DDS) that may be used by the UE 602 for data services, and a second USIM having a non-DDS (n-DDS) that may be used by the UE 602 for voice calls and/or data services. In some examples, each USIM may communicate in a respective RAT. For example, the DDS USIM may utilize an NR RAT to communicate with the cell 608 or 610, and the n-DDS USIM may utilize an LTE RAT to communicate with cell 606.

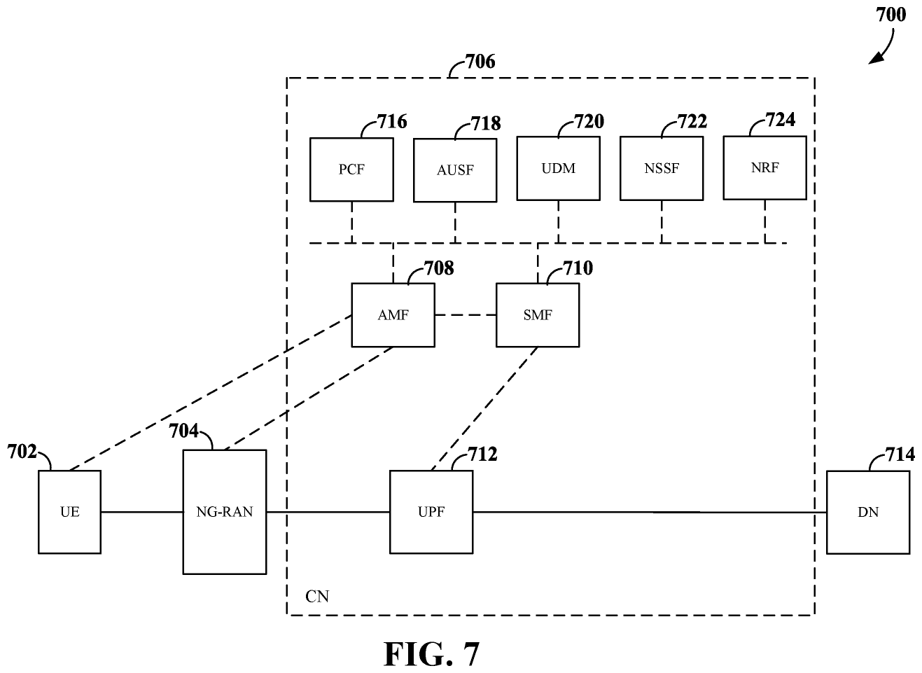

Referring now to FIG. 7, by way of example and without limitation, a block diagram illustrating an example of various components of a 5G wireless communication system (5GS) 700 is provided. In some examples, the 5GS 700 may be implemented in the wireless communication systems 100, 200, and 300 described above and illustrated in FIGS. 1-3. The 5GS 700 can include a UE 702, a NG-RAN 704, and a core network 706 (e.g., a 5G core network (CN)). The NG-RAN 704 may be a 5G RAN and corresponds, for example, to the RAN 200 or 300 described above and illustrated in FIG. 2/3. In addition, the UE 702 may correspond to any of the UEs or other scheduled entities shown in FIG. 1, 2, or 3. By virtue of the wireless communication system 700, the UE 702 may be enabled to carry out data communication with an external data network (DN) 714, such as (but not limited to) the Internet or an Ethernet network.

The core network 706 may include, for example, an access and mobility management function (AMF) 708, a session management function (SMF) 710, and a user plane function (UPF) 712. The AMF 708 and SMF 710 can employ control plane (e.g., non-access stratum (NAS)) signaling to perform various functions related to mobility management and session management for the UE 702. For example, the AMF 708 provides connectivity, mobility management and authentication of the UE 702, while the SMF 710 provides session management of the UE 702 (e.g., processes signaling related to protocol data unit (PDU) sessions between the UE 702 and the external DN 714. The UPF 712 provides user plane connectivity to route 5G (NR) packets to/from the UE 702 via the NG-RAN 704.

As used herein, the term non-access stratum (NAS) may, for example, generally refer to protocols between the UE 702 and the core network 706 that are not terminated in the NG-RAN 704. In addition, the term access stratum (AS) may, for example, generally refer to a functional grouping consisting of the parts in the NG-RAN 704 and in the UE 702, and the protocols between these parts being specific to the access technique (i.e., the way the specific physical media between the UE 702 and the NG-RAN 704 is used to carry information).

The core network 706 may further include other functions, such as a policy control function (PCF) 716, authentication server function (AUSF) 718, unified data management (UDM) 720, network slice selection function (NSSF) 722, a network repository function (NRF) 724, and other functions (not illustrated, for simplicity). The PCF 716 provides policy information (e.g., rules) for control plane functions, such as network slicing, roaming, and mobility management. In addition, the PCF 716 supports 5G quality of service (QoS) policies, and other types of policies. The AUSF 718 performs authentication of UEs (e.g., UE 702). The UDM 720 facilitates generation of authentication and key agreement (AKA) credentials, performs user identification and manages subscription information and UE context. The NSSF 722 redirects traffic to a network slice. Network slices may be defined, for example, for different classes of subscribers or use cases, such as smart home, Internet of Things (IoT), connected car, smart energy grid, etc. Each use case may receive a unique set of optimized resources and network topology (e.g., a network slice) to meet the connectivity, speed, power, and capacity requirements of the use case. The NRF 724 is a central repository for all of the 5G network functions (NFs) in the wireless communication system 700. The NRF 724 enables NFs to register and discover one another. In addition, the NRF 724 supports a 5G service-based architecture (SBA).

To establish a connection to the core network 706 (e.g., a 5G core network) via the NG-RAN 704, the UE 702 may transmit a registration request to the AMF 708 of the core network 706 via the NG-RAN 704. The AMF 708 may then initiate non access stratum (NAS) level authentication between the UE 702 and the core network 700 (e.g., via the AUSF 718 and UDM 720). The AMF 708 may then retrieve mobility subscription data, SMF selection data, and UE context and communicate with the PCF 716 for policy association for the UE 702. The AMF 708 may then send a NAS secure registration accept message to the UE 702 to complete the registration.

Once the UE 702 has registered with the core network 706, the UE 702 may transmit a PDU session establishment request to establish one or more PDU sessions to the core network 706 via the NG-RAN 704. The AMF 708 and SMF 710 may process the PDU session establishment request and establish a data network session (DNS) between the UE 702 and the external DN 714 via the UPF 712. A DNS may include one or more sessions (e.g., data sessions or data flows) and may be served by multiple UPFs 712 (only one of which is shown for convenience). Examples of data flows include, but are not limited to, Internet Protocol (IP) flows, Ethernet flows and unstructured data flows.

With regard to paging, a connection may be established either due to UE data becoming available on the CN side (e.g., CN 706) or at the UE side (e.g., UE 702) itself. Before an actual connection establishment begins, the network initiates a paging procedure. In examples where the UE is in an RRC idle state, the CN may determine the RAN node(s) to route the UE data by engaging in a CN-initiated paging procedure to identify one or more gNBs or base stations under which the UE has current coverage. In examples where the UE is in an RRC inactive state, the UE's position may be known by the network on a RAN Notification Area (RNA) level, which may cover multiple gNBs. Since, from the CN perspective, the UE is still in a connected state, the CN may not directly send a paging message, but may forward user data via downlink to the last known gNB that has served the UE to perform a RAN-initiated paging procedure. In some examples, RAN paging may include the forwarding of paging messages to other gNBs within the RNA of the UE.

In some examples, the paging messages may be transmitted over a paging control channel (PCCH) or using DCI messaging. In RRC idle and RRC inactive states, the UE may monitor for paging messages using paging channels, where the UE can monitor a single paging occasion (PO) per its idle mode discontinuous reception (DRX) cycle. A PO is configured as a set of PDCCH monitoring occasions that include multiple slots where paging DCI may be sent. The PO is determined by the UE, based on the UE's identity (e.g., 5G-S-Temporary Mobile Subscriber Identity (5G-S-TMSI)) and additional parameters signaled by the network (e.g., DRX configuration).

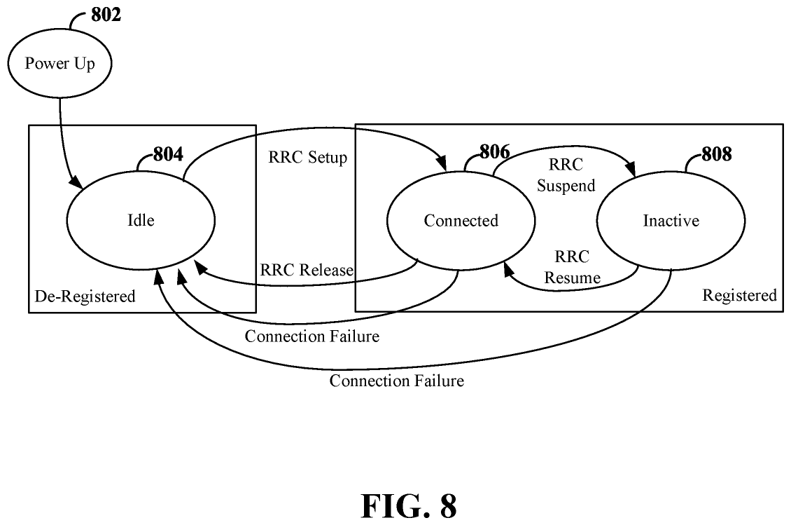

FIG. 8 illustrates an example of 5G state transitions according to some aspects. As shown in FIG. 8, when a UE first powers up 802, the UE is in a disconnected state (e.g., RRC idle state 804) in which the UE is not registered with (e.g., de-registered from) a 5G core network. The UE can move from the RRC idle state 804 to an RRC connected state 806 during initial attach (registration) or with connection establishment, as described above, to register with and connect to the 5GS. For example, the UE can perform a random access procedure (RACH) in connection with FIG. 8 to transmit an RRC setup request and transition from the RRC idle state 804 to the RRC connected state 806.

While in the RRC connected state 806, if there is no activity (e.g., no wireless data for transmission) at the UE for a period of time, the UE can transmit an RRC suspend request (e.g., to a network entity) to move from the RRC connected state 806 to an RRC inactive state 808. Upon receiving the RRC suspend request, the UE context of the UE can be stored in the last serving base station (e.g., gNB) or an anchor gNB of the RNA within which the UE is located. In the RRC inactive state 808, the UE remains registered with the 5GS.

To transition back from the RRC inactive state 808 to the RRC connected state 806, the UE may transmit an RRC resume request to the NG-RAN (e.g., gNB). The UE may transmit the RRC resume request, for example, when a low activity period is over and there is uplink data available in the uplink buffer for the UE to transmit to the NG-RAN, or when there is downlink data present in the NG-RAN for the UE and the NG-RAN pages the UE. For example, the UE may monitor a paging channel on the PDCCH during paging occasions, which may be determined based on a discontinuous reception (DRX) cycle. If a page is received for the UE from the NG-RAN, the UE may send the RRC resume request to the NG-RAN. The UE may be paged, for example, in the RNA configured for the UE. The RNA may, therefore, define an area within which the UE may move in the RRC inactive state without notifying the network. The RNA can be UE-specific and configurable by the NG-RAN.

If the UE detects a new RNA during wake-up prior to the paging occasion, the UE may transmit the RRC resume request to the NG-RAN to perform an RNA update procedure, as described above. For example, prior to the paging occasion, the UE may obtain cell measurements and perform a cell reselection, if necessary, based on the cell measurements and various other cell reselection criteria. If the selected cell is in a new RNA (by comparison with the configured RNA in the UE), the UE may determine that the UE should perform an RNA update procedure. In some examples, the UE may transmit the RRC resume request to perform the RNA update and then transition back to the RRC inactive state if no paging message is received for the UE.

The UE can transition back to the RRC idle state 804 from the RRC inactive state 808 or from the RRC connected state 806. For example, while in the RRC inactive state 808 or RRC connected state 806, the UE may transition back to the RRC idle state 804 upon experiencing a connection failure (e.g., radio link or beam failure). In addition, while the UE is in the RRC connected state 806, the UE may transmit an RRC release request to the NG-RAN to detach from the 5GS and transition back to the RRC idle state 804. The NG-RAN may provide an RRC connection release message back to the UE that includes, for example, dedicated cell reselection priority information that may be utilized by the UE in cell reselection to transition back to the RRC connected state 806.

In RRC Idle state 804, the UE is not registered to a particular cell, hence the UE does not have an AS context and any other information received from the network. The network initiates the RRC connection release procedure to move a UE in the RRC connected 806 to the RRC idle state 804. The UE may wake up periodically (e.g., according to a configured DRX cycle) and monitor for paging messages from the network. The network can reach UEs in the RRC idle state through paging messages, and to notify UEs in RRC idle state a change of system information and ETWS (Earthquake and Tsunami Warning System)/CMAS (Commercial Mobile Alert System) indications through short messages. Both paging messages and short messages are addressed with P-RNTI (paging radio network temporary identifier) on PDCCH, but while the former is sent on PCCH, the latter is sent over PDCCH.

While in the RRC idle state 804, the UE monitors the paging channels for CN-initiated paging. In the RRC inactive state 808, the UE also monitors paging channels for RAN-initiated paging. A UE may not monitor paging channels continuously. For example, paging DRX may be defined or configured such that when the UE in RRC idle state 804 or RRC inactive state 808 is only required to monitor paging channels during one Paging Occasion (PO) per DRX cycle. In this state, the UE itself manages mobility based on the network configurations via cell (re-) selections. The UE can perform neighboring cell measurements which are used for cell (re-) selections. On a transition from RRC connected state 806 or RRC inactive state 808 to RRC idle state 804, a UE may camp on a cell as a result of cell selection according to the frequency assigned by RRC in the state transition message, if any. In RRC idle state 804, the UE cannot transmit anything in the uplink except for PRACH as part of a random access (RACH) procedure initiated when the UE desires to transition to RRC connected state 806 or to request for on-demand system information.

During RRC inactive state 808, the UE may periodically monitor for paging messages (e.g., using a DRX cycle) from the network. The network can reach UEs in RRC inactive state 808 using paging messages, and to notify UEs of system information and ETWS/CMAS indications through short messages. Both paging messages and short messages are addressed with P-RNTI on PDCCH, but while the former is sent on PCCH, the latter is sent over PDCCH directly. The UE may monitor a Paging channel for CN paging using 5G-S-TMSI and RAN paging using full I-RNTI (Inactive RNTI). I-RNTI is used to identify the suspended UE context of a UE in RRC inactive state. The network assigns I-RNTI to the UE when moving from RRC connected state to RRC inactive state in an RRCRelease message within SuspendConfig. In RRC inactive state, the UE cannot transmit anything in the uplink except for PRACH as part of RACH procedure initiated when UE desires to transit to RRC connected state (to transmit RRCResumeRequest) or to request for on-demand system information. A base station (e.g., gNB) can transition a UE from RRC connected to RRC inactive state by transmitting RRCRelease message with suspendConfig.

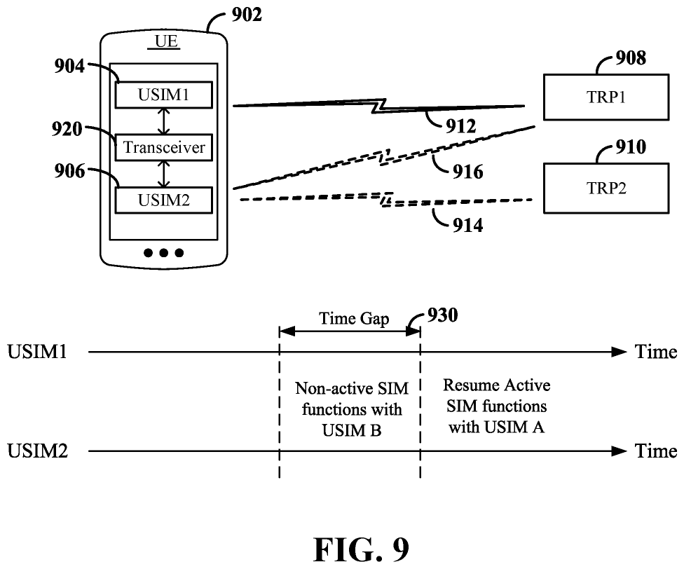

FIG. 9 is a diagram illustrating a multi-SIM wireless communication device according to some aspects. The terms multi-subscriber identity module card (MSIM) and multi-SIM may be used interchangeably in this disclosure. In the example shown in FIG. 9, the multi-SIM wireless communication device (UE 902) can include two or more USIMs (e.g., USIM1 904 and USIM2 906). In one aspect, each USIM 904 and 906 may be a physical, embedded, or virtual USIM. In some examples, each USIM 904 and 906 may be configured to enable the UE 902 to transmit/receive communication signals (e.g., signals 912, 914, and/or 916) over carrier frequency in a common frequency band using the same RAT. In some examples, each USIM 904 and 906 may be configured to enable the UE 902 to communicate with a different RAT. In some aspects, USIM1 904 can be configured to enable the UE 902 to communicate with a first network entity 908 (e.g., TRP1) utilizing a first RAT (e.g., NR), and USIM2 906 can be configured to enable the UE 902 to communicate with a second network entity 910 (e.g., TRP2) utilizing a second RAT (e.g., LTE). In one example, USIM1 904 can enable the UE to transmit and/or receive communication signals 912 to/from TRP1 908 (e.g., NR TRP) over a first carrier frequency in a first frequency band of an NR frequency range (e.g., FR1 or FR2), and USIM2 906 can enable the UE to transmit and/or receive communication signals 914 to/from TRP2 910 (e.g., LTE TRP) over a second carrier frequency in a second frequency band of an LTE frequency range. In some aspects, the USIMs 904 and 906 can be associated with different network operators or service providers.

In one example, USIM1 904 may be configured with a DDS for communication of data (e.g., e-mail, Internet, etc.) with an NR network entity (e.g., TRP 908), and USIM2 906 may be configured with a n-DDS for communication of data and/or voice signals (e.g., communication signal 914) with an LTE network entity (e.g., TRP 910). In one example, USIM1 904 may be in a radio resource control (RRC) connected state, while USIM2 906 may be in an RRC idle mode until a voice call is made or received by the UE 902. This configuration of USIMs 904 and 906 may be referred to as a dual SIM dual standby (DSDS) mode in which the UE 902 uses a single transceiver 920 for both USIMs 904 and 906. Both USIMs 904 and 906 can be active or enabled, but only one USIM may use the transceiver 920 for same direction (e.g., transmission or reception) communications at a time. For example, USIM1 904 may be in an RRC connected state to send/receive data to/from the NR network, while USIM2 906 may be in an RRC idle mode. USIM2 906 may periodically access the transceiver and utilize a receive chain (e.g., RF/baseband processor) in the UE 902 to receive and decode any paging messages from the LTE network (e.g., TRP2 910). Thus, USIM2 906 can periodically interrupt receive operations (e.g., downlink operations) of the USIM1 904 to receive and decode a page. During a paging time window of USIM2 906 within which USIM2 906 may receive the page, USIM1 904 may continue to use the transceiver for transmit operations (e.g., uplink operations). In other examples, USIM1 904 may be configured with the n-DDS, while SIM2 may be configured with the DDS.

When this disclosure describes a USIM (e.g., USIM1 904 and USIM2 906) of a multi-SIM UE (e.g., UE 902) as being in a certain RRC state (e.g., RRC connected state, RRC inactive state, and RRC idle state), the multi-SIM UE equipped with that USIM is in the stated RRC state when the multi-SIM UE uses the USIM for communication with a corresponding network.

In some examples, USIMs 904 and 906 may be in a passive mode MSIM configuration, where one USIM (e.g., USIM 904 or 906) may be selected for use at a given time. Generally speaking, the USIMs 904 and 906 when configured in the passive mode may share a single cellular transceiver (e.g., transceiver 920) and have a logical connection to a single network (e.g., using TRP1 908) at any given time. In some examples, USIM1 904 and USIM2 906 may operate in a dual SIM, dual standby (DSDS) operating mode, where each USIM can be used for an idle-mode cellular network connection. Here, USIM1 904 and USIM2 906 may also share a single cellular transceiver (e.g., transceiver 920), but when a primary cellular radio connection (e.g., via TRP1 908) is active, the second radio connection (e.g., associated with USIM2 906) is limited. Using time multiplexing, two radio connections of different USIMs 904 and 906 may be maintained in the RRC idle mode. In some examples, when a first USIM (e.g., USIM 904) is used for an active call (i.e., on-call) with the network, the UE may not be able to receive paging for a second USIM (e.g., USIM 906), which may leave the connection of the second USIM unavailable for the duration of the call using the first USIM. However, network registration of the second USIM (e.g., USIM 906) can be maintained.

In some examples, during a data session, in DSDS mode, data connection on a primary connection (e.g., communication 912) may be managed on a “best effort” basis to accommodate reception of the secondary connection (e.g., communication 916) paging. DSDS devices that support Voice over Wi-Fi may be configured to generally allow voice connections to be maintained over the Wi-Fi bearer regardless of the status of the cellular bearers. In some examples, USIM1 904 and USIM2 906 may be configured to operate under a dual SIM dual active (DSDA) mode, where each USIM may be used in either an RRC idle state or an RRC connected state, irrespective of the RRC state of the other USIM. In this example, each USIM may be configured with a dedicated transceiver.

In some aspects, when the UE 902 (a scheduled entity) is in an RRC connected state using an active USIM (e.g., USIM1 904), the UE can perform certain idle/inactive RRC mode activities with the non-active USIM (e.g., USIM2 906). To that end, the UE can request a network entity (e.g., gNB, CU/DU, or base station associated with the active USIM) to configure one or more time gaps (e.g., tune-away time intervals) with the active USIM so that the UE can stop or pause performing certain communication functions (e.g., wireless transmission/reception) with the network associated with the active USIM during the requested time gap(s). For example, the UE can send the request for one or more time gaps in UE Assistance Information using RRC signaling, and, in response, the network entity (e.g., gNB or a base station) can configure (e.g., using RRC Reconfiguration) the requested time gaps for the active USIM.

In some aspects, during a time gap, the UE 902 can perform certain functions associated with the non-active USIM (e.g., USIM2 906), for example, monitoring and receiving page messages, receiving SIBs, performing idle mode measurements, etc., in the network associated with the non-active USIM. In some aspects, the UE can stop or suspend some or all operations related to radio link monitoring (RLM) and/or beam failure detection (BFD) events associated with the active USIM during the time gaps (e.g., time gap 930). In some aspects, if the UE terminates a time gap early, the UE may signal the early termination to the network entity, and may resume RLM and/or BFD if that is stopped or suspended during the time gap.

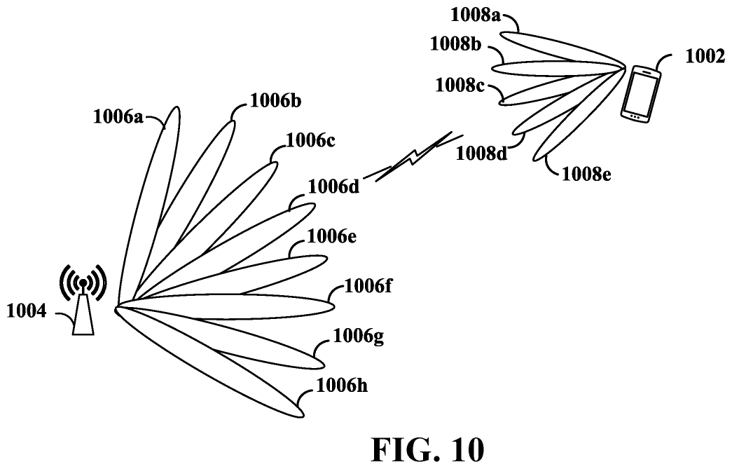

FIG. 10 is a diagram illustrating communication between a network entity 1004 (e.g., base station, gNB) and a scheduled entity (UE 902) using beamformed signals according to some aspects. The network entity 1004 may be any of the network entities (e.g., base stations, gNBs, CU/DU) or scheduling entities illustrated in FIGS. 1-3, 5-7, and/or 9. The UE 1002 may be any of the UEs or scheduled entities illustrated in FIGS. 1-3, 5-7, and/or 9. In one example, the UE 1002 may be a MSIM or multi-SIM wireless communication device (e.g., UE 902) described above in relation with FIG. 9.

The network entity 1004 may generally be capable of communicating with the UE 1002 using one or more transmit beams, and the UE 1002 may further be capable of communicating with the network entity 1004 using one or more receive beams. As used herein, the term transmit beam refers to a beam on the network entity 1004 that may be utilized for downlink or uplink communication with the UE 1002. In addition, the term receive beam refers to a beam on the UE 1002 that may be utilized for downlink or uplink communication with the network entity 1004.

In the example shown in FIG. 10, the network entity 1004 is configured to generate a plurality of transmit beams 1006a-1006h, each associated with a different spatial direction. In addition, the UE 1002 is configured to generate a plurality of receive beams 1008a-1008e, each associated with a different spatial direction. It should be noted that while some beams are illustrated as adjacent to one another, such an arrangement may be different in different aspects. For example, transmit beams 1006a-1006h transmitted during a same symbol may not be adjacent to one another. In some examples, the network entity 1004 and UE 1002 may each transmit more or less beams distributed in all directions (e.g., 360 degrees) and in three-dimensions. In addition, the transmit beams 1006a-1006h may include beams of varying beam width. For example, the network entity 1004 may transmit certain signals (e.g., SSBs) on wider beams and other signals (e.g., CSI-RSs) on narrower beams.

The network entity 1004 and UE 1002 may select one or more transmit beams 1006a-1006h on the network entity 1004 and one or more receive beams 1008a-1008e on the UE 1002 for communication of uplink and downlink signals therebetween using a beam management procedure. In one example, during initial cell acquisition, the UE 1002 may perform a P1 beam management procedure to scan the plurality of transmit beams 1006a-1006h on the plurality of receive beams 1008a-1008e to select a beam pair link (e.g., one of the transmit beams 1006a-1006h and one of the receive beams 1008a-1008e) for a physical random access channel (PRACH) procedure for initial access to the cell. For example, periodic SSB beam sweeping may be implemented on the network entity 1004 at certain intervals (e.g., based on the SSB periodicity). Thus, the network entity 1004 may be configured to sweep or transmit an SSB on each of a plurality of wider transmit beams 1006a-1006h during the beam sweeping interval. The UE may measure the reference signal received power (RSRP) of each of the SSB transmit beams on each of the receive beams of the UE and select the transmit and receive beams based on the measured RSRP. In an example, the selected receive beam may be the receive beam on which the highest RSRP is measured and the selected transmit beam may have the highest RSRP as measured on the selected receive beam.

After completing the PRACH procedure, the network entity 1004 and UE 1002 may perform a P2 beam management procedure for beam refinement at the network entity 1004. For example, the network entity 1004 may be configured to sweep or transmit a CSI-RS on each of a plurality of narrower transmit beams 1006a-1006h. Each of the narrower CSI-RS beams may be a sub-beam of the selected SSB transmit beam (e.g., within the spatial direction of the SSB transmit beam). Transmission of the CSI-RS transmit beams may occur periodically (e.g., as configured via radio resource control (RRC) signaling by the gNB), semi-persistently (e.g., as configured via RRC signaling and activated/deactivated via medium access control-control element (MAC-CE) signaling by the gNB), or aperiodically (e.g., as triggered by the gNB via downlink control information (DCI)). The UE 1002 is configured to scan the plurality of CSI-RS transmit beams 1006a-1006h on the plurality of receive beams 1008a-1008e. The UE 1002 then performs beam measurements (e.g., RSRP, SINR, etc.) of the received CSI-RSs on each of the receive beams 1008a-1008e to determine the respective beam quality of each of the CSI-RS transmit beams 1006a-1006h as measured on each of the receive beams 1008a-1008e.

The UE 1002 can then generate and transmit a Layer 1 (L1) measurement report, including the respective beam index (e.g., CSI-RS resource indicator (CRI)) and beam measurement (e.g., RSRP or SINR) of one or more of the CSI-RS transmit beams 1006a-1006h on one or more of the receive beams 1008a-1008e to the network entity 1004. The network entity 1004 may then select one or more CSI-RS transmit beams on which to communicate downlink and/or uplink control and/or data with the UE 1002. In some examples, the selected CSI-RS transmit beam(s) have the highest RSRP from the L1 measurement report. Transmission of the L1 measurement report may occur periodically (e.g., as configured via RRC signaling by the gNB), semi-persistently (e.g., as configured via RRC signaling and activated/deactivated via MAC-CE signaling by the gNB), or aperiodically (e.g., as triggered by the gNB via DCI).

The UE 1002 may further select a corresponding receive beam on the UE 1002 for each selected serving CSI-RS transmit beam to form a respective beam pair link (BPL) for each selected serving CSI-RS transmit beam. For example, the UE 1002 can utilize the beam measurements obtained during the P2 procedure or perform a P3 beam management procedure to obtain new beam measurements for the selected CSI-RS transmit beams to select the corresponding receive beam for each selected transmit beam. In some examples, the selected receive beam to pair with a particular CSI-RS transmit beam may be the receive beam on which the highest RSRP for the particular CSI-RS transmit beam is measured.

In some examples, in addition to performing CSI-RS beam measurements, the network entity 1004 may configure the UE 1002 to perform SSB beam measurements and provide an L1 measurement report containing beam measurements of SSB transmit beams 1006a-1006h. For example, the network entity 1004 may configure the UE 1002 to perform SSB beam measurements and/or CSI-RS beam measurements for beam failure detection (BRD), beam failure recovery (BFR), cell reselection, beam tracking (e.g., for a mobile UE 1002 and/or network entity 1004), or other beam optimization purpose.

In addition, when the channel is reciprocal, the transmit and receive beams may be selected using an uplink beam management scheme. In an example, the UE 1002 may be configured to sweep or transmit on each of a plurality of receive beams 1008a-1008e. For example, the UE 1002 may transmit an SRS on each beam in the different beam directions. In addition, the network entity 1004 may be configured to receive the uplink beam reference signals on a plurality of transmit beams 1006a-1006h. The network entity 1004 then performs beam measurements (e.g., RSRP, SINR, etc.) of the beam reference signals on each of the transmit beams 1006a-1006h to determine the respective beam quality of each of the receive beams 1008a-1008e as measured on each of the transmit beams 1006a-1006h.

The network entity 1004 may then select one or more transmit beams on which to communicate downlink and/or uplink control and/or data with the UE 1002. In some examples, the selected transmit beam(s) have the highest RSRP. The UE 1002 may then select a corresponding receive beam for each selected serving transmit beam to form a respective beam pair link (BPL) for each selected serving transmit beam, using, for example, a P3 beam management procedure, as described above.

In one example, a single CSI-RS transmit beam (e.g., beam 1006d) on the network entity 1004 and a single receive beam (e.g., beam 1008c) on the UE may form a single BPL used for communication between the network entity 1004 and the UE 1002. In another example, multiple CSI-RS transmit beams (e.g., beams 1006c, 1006d, and 1006e) on the network entity 1004 and a single receive beam (e.g., beam 1008c) on the UE 1002 may form respective BPLs used for communication between the network entity 1004 and the UE 1002. In another example, multiple CSI-RS transmit beams (e.g., beams 1006c, 1006d, and 1006e) on the network entity 1004 and multiple receive beams (e.g., beams 1008c and 1008d) on the UE 1002 may form multiple BPLs used for communication between the network entity 1004 and the UE 1002. In this example, a first BPL may include transmit beam 1006c and receive beam 1008c, a second BPL may include transmit beam 1008d and receive beam 1008c, and a third BPL may include transmit beam 1008e and receive beam 1008d.

The UE 1002 performs radio link monitoring (RLM) on an active downlink (DL) BWP of the primary serving cell (PCell) of the master cell group (MCG). If the UE is configured with a secondary cell group (SCG), then the UE also monitors downlink radio link quality on the active DL BWP of the primary SCG Cell (PSCell). PCell and PSCell are collectively known as SpCell (Special Cell). Radio link failure (RLF) occurs when the UE is not able to find any suitable beam or BPL to recover or maintain the connection between the network entity 1004 and UE 1002 using beam failure recovery (BFR). The UE may use one or more timers (or counters) in radio link monitoring (RLM) and beam failure detection (BFD) procedures. For example, the UE may start a BFD timer as soon as a beam failure instance (BFI) is detected and keeps incrementing a BFD counter by 1 for every BFI detected. When the BFD counter reaches a predetermined threshold (e.g., maximum BFI count), a beam failure recovery process is triggered. If the timer expires without triggering beam failure recovery, the UE can assume that there is no more BFD and can reset the BFD counter. In some aspects, the UE can start a RLM timer as soon as radio link failure is detected and keeps incrementing a RLM timer by 1 for every radio link failure detected. When the RLM counter reaches a predetermined threshold (e.g., maximum RLM count), a radio link failure recovery process can be triggered.

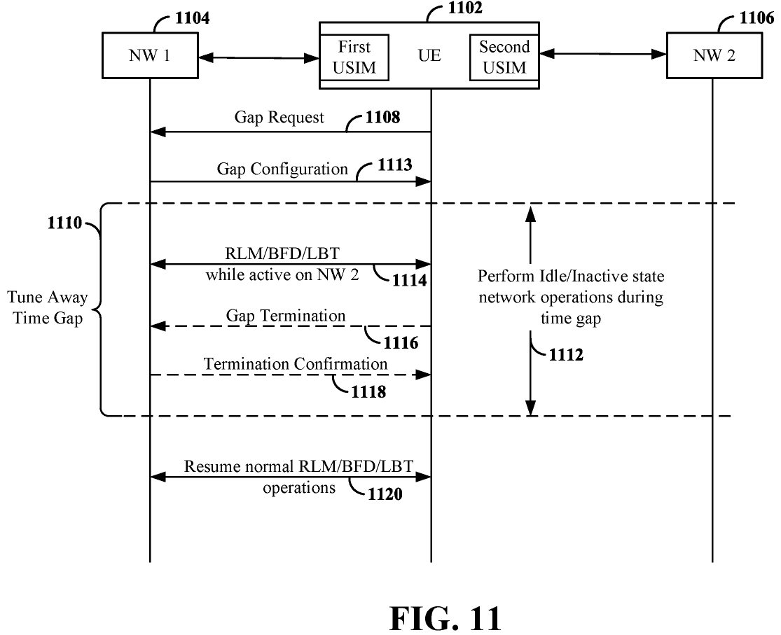

FIG. 11 is a diagram illustrating a MSIM wireless communication device using a time gap created with an active SIM for performing network activities for a non-active SIM according to some aspects. In one example, the MSIM wireless communication device (e.g., UE 1102) may be the same as the MSIM UE 902 or any of the UEs or scheduled entities described above in relation to FIGS. 1, 2, 3, 5-7, 9, and/or 10.

The UE 1102 may have multiple USIMs, for example, a first USIM associated with a first network 1104 (NW 1) and a second USIM associated with a second network 1106 (NW 2). In some aspects, the first network 1104 and the second network 1106 may be LTE and/or NR networks. The UE 1102 can have one active connection with the first network 1104 using the first USIM or the second network 1106 using the second USIM. In one example, the UE 1102 can be in an RRC connected state (e.g., RRC connected state 806) with the first network 1104 that is associated with the first USIM. In one aspect, the UE can transmit a request (e.g., gap request 1108) to the first network 1104 to request one or more time gaps. During the time gap (e.g., time gap 1110), the UE 1102 can perform RRC idle/inactive state network operations 1112 with the second network 1106 that is associated with the second USIM, while the UE remains in an RRC connected state on the first USIM. In an RRC connected state, the UE can transmit the gap request 1108 using RRC signaling (e.g., UE Assistance Information message). In response to the gap request 1108, the first network 1104 (e.g., a network entity, gNB, CU/RU, etc.) can provide gap configuration information 1113 using RRC signaling (e.g., RRC Reconfiguration) to the UE 1102.

According to the gap configuration information 1113, the UE can configure one or more time gaps (e.g., time gap 1110) for performing network operations on the second network 1106 while remaining in the RRC connected state on the first USIM that is associated with the first network 1104. In some aspects, during the time gap 1110, the UE 1102 can perform RRC idle and/or inactive state operations, for example, monitoring and receiving page messages, receiving system information (e.g., SIBs), idle mode measurements, etc. in the second network. In some aspects, the UE may perform RLM, BFD, and/or LBT (listen-before-talk) related operations 1114 during the time gap 1110 while the UE can perform the RRC idle/inactive state network operations on the second network 1106.

In some aspects, the UE 1102 can perform RRC idle/inactive state operations on the second network 1106 in the time gap, while the UE 1102 can perform modified RLM, BFD, and/or LBT related procedures. For example, the UE can use timers or counters for monitoring RLM, BFD, and/or LBT at the upper network layers (e.g., MAC layer) on the first USIM that is associated with the first network 1104. In one aspect, the UE 1102 may stop or suspend RLM, BFD, and/or LBT operations with the first network 1104 during the time gap. In one aspect, the UE may finish the RRC idle/inactive state network operations before the time gap 1110 expires or terminates. In that case, the UE may transmit a gap termination indication 1116 to the first network 1104. In response to the gap termination indication 1116, the first network 1104 (e.g., a base station, gNB) may provide a termination confirmation 1118 to the UE. After the time gap 1110, the UE can resume nominal RLM, BFD, and/or LBT procedures 1120 on the first USIM. More detailed examples will be provided below for the above described procedures.

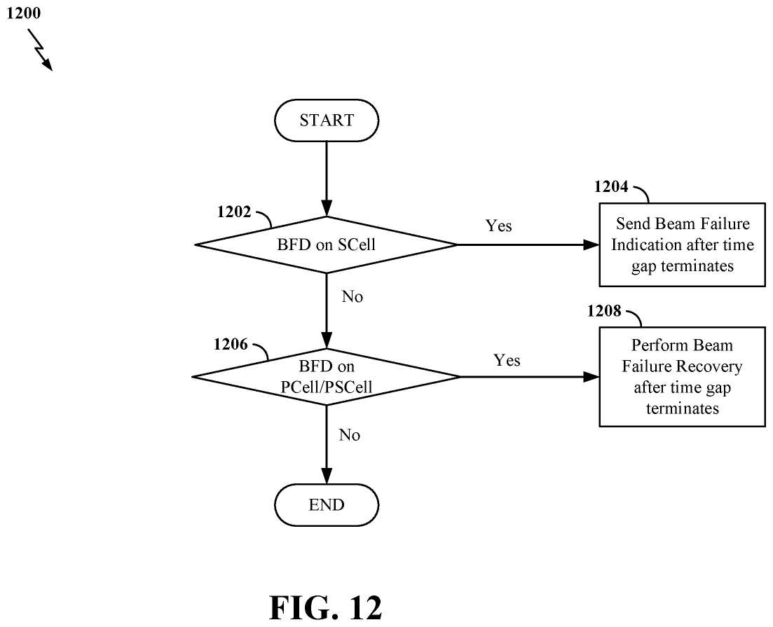

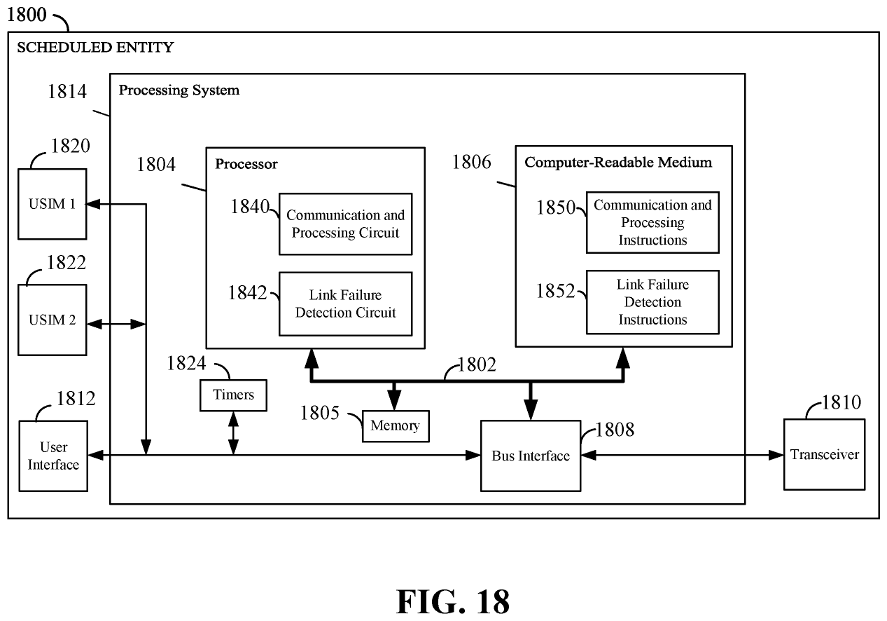

FIG. 12 is a flow chart illustrating a procedure 1200 for monitoring beam failure using a time gap at a MSIM wireless communication device according to some aspects. As described below, some or all illustrated features may be omitted in a particular implementation within the scope of the present disclosure, and some illustrated features may not be required for all implementations. In some examples, the procedure 1200 may be carried out by the scheduled entity 1800 illustrated in FIG. 18. In some examples, the process 1200 may be carried out by any suitable apparatus or means for carrying out the functions or algorithm described below.

As described above, a scheduled entity (e.g., UE 1102) can use a time gap (e.g., time gap 1110) configured on an active USIM (e.g., a first USIM in an RRC connected state) to perform certain network activities on a non-active SIM (e.g., a second USIM in an RRC idle/inactive state). During the time gap, the UE can continue a beam failure detection (BFD) procedure (e.g., a modified BFD procedure) on the active USIM. For example, the timers and/or counters used for BFD can continue at the upper layers (e.g., MAC layer or higher) while the UE can use the physical layer (PHY) for performing the network activities (e.g., monitoring and receiving page messages, receiving SIBs, performing idle mode measurements, etc.) for the non-active USIM (e.g., in RRC inactive/idle state). During the time gap, the UE's PHY layer (e.g., transceiver) may not be able to provide measurements for BFD on the active USIM because the PHY layer is being used by the non-active USIM. In some aspects, the UE can use predetermined, default, or assumed measurement values (e.g., worst case values) for BFD purpose during the time gap.

At decision block 1202, the UE can determine whether BFD occurs on an SCell or not for the active USIM. If BFD occurred on the SCell, at block 1204, the UE can send a beam failure indication (BFI) to the network associated with the active USIM after the time gap is terminated. In one example, the UE can send the BFI in a MAC CE (or an RRC message) destined to the network associated with the first SIM. The time gap is terminated when the time gap expires as configured by the network entity (e.g., a base station, gNB) or terminated by the UE earlier than the configured time gap expiration time. For example, the UE may terminate the time gap before the time gap expires when the UE has no more network activities or operations to perform for the non-active USIM (e.g., in RRC inactive/idle mode) before the time gap ends.

At decision block 1206, the UE can determine whether BFD occurs on a PCell or PSCell for the active USIM. If BFD occurred on a PCell or PSCell, at block 1208, the UE can perform beam failure recovery after the time gap is terminated. The time gap is terminated when the time gap expires as configured by the network entity (e.g., a base station, gNB) or terminated by the UE earlier than the configured time gap expiration time. For example, the UE may terminate the time gap before the time gap expires when the UE has no more network activities or operations to perform for the non-active USIM (e.g., in RRC inactive/idle mode) before the time gap ends. The UE can repeat the procedure 1200 to monitor BFD before the time gap is terminated.

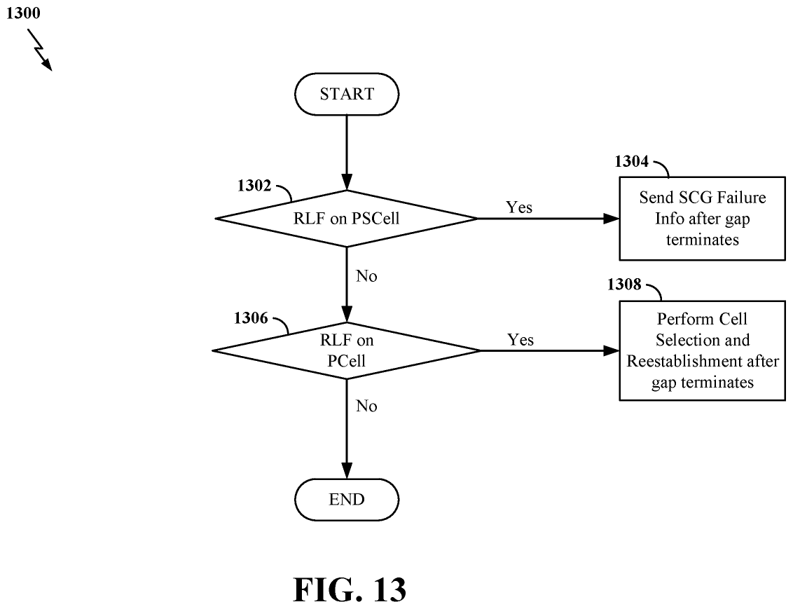

FIG. 13 is a flow chart illustrating a procedure 1300 for monitoring radio link failure (RLF) using a time gap at a MSIM wireless communication device according to some aspects. As described below, some or all illustrated features may be omitted in a particular implementation within the scope of the present disclosure, and some illustrated features may not be required for all implementations. In some examples, the procedure 1300 may be carried out by the scheduled entity 1800 illustrated in FIG. 18. In some examples, the process 1300 may be carried out by any suitable apparatus or means for carrying out the functions or algorithm described below.

As described above, a scheduled entity (e.g., UE) can use a time gap (e.g., time gap 1110) on an active USIM (e.g., a first USIM in an RRC connected state) to perform certain network activities on a non-active USIM (e.g., a second USIM in an RRC idle/inactive state). During the time gap, the UE can continue a radio link monitoring (RLM) procedure on the active USIM. For example, the timers and/or counters used for RLM can continue at the upper layers (e.g., MAC layer or higher) while the UE can use the PHY layer (e.g., transceiver) for performing network activities (e.g., monitoring and receiving page messages, receiving SIBs, performing idle mode measurements, etc.) on the non-active SIM. During the time gap, the UE's PHY layer may not be able to provide measurements for RLM on the active USIM because it is used for the non-active USIM (e.g., in RRC inactive/idle mode). In some aspects, the UE can use predetermined, default, or assumed measurement values (e.g., worst case values) for RLM purpose for the active USIM.

At decision block 1302, the UE can determine whether RLF occurs on a PSCell or not for the active USIM. For example, the UE may determine the downlink radio link quality of the primary cell (e.g., PCell) for determining RLF at the higher layers (e.g., RRC layer). The UE may determine the downlink radio link quality without receiving the actual measurements from the PHY layer. For example, the UE can use a predetermined or assumed value (e.g., worst case values) for the radio link quality during the time gap.

At block 1304, if RLF occurred on a PSCell, the UE can send secondary cell group (SCG) failure information to the network associated with the active USIM after the time gap is terminated. In one example, the UE can send the SCG failure information using RRC signaling with the network associated with the active SIM. The time gap is terminated when the time gap expires as configured by the network entity (e.g., a base station, gNB) or terminated by the UE. For example, the UE may terminate the time gap before the time gap expires when the UE has no more network activities to perform during the time gap for the non-active USIM.

At decision block 1306, the UE can determine whether RLF occurs on a PCell associated with the active USIM. The UE may determine the RLF without receiving the actual measurements from the PHY layer. For example, the UE can use a predetermined or assumed value (e.g., worst case values) for the radio link quality of the PCell during the time gap. At block 1308, if RLF occurred on the PCell, the UE can perform cell selection and/or re-establishment after the time gap is terminated. The UE can repeat the procedure 1300 to monitor RLF for the active USIM before the time gap is terminated or expired.

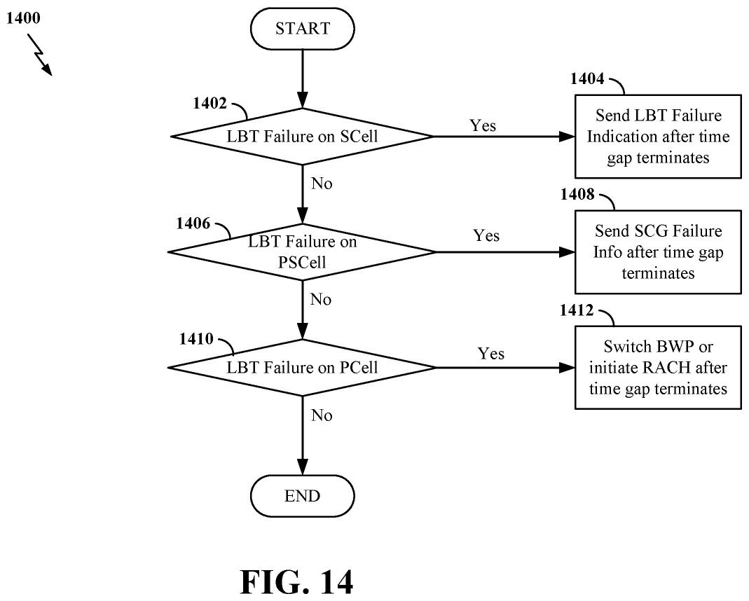

FIG. 14 is a flow chart illustrating a procedure 1400 for monitoring listen-before-talk (LBT) failure using a time gap at a MSIM wireless communication device according to some aspects. As described below, some or all illustrated features may be omitted in a particular implementation within the scope of the present disclosure, and some illustrated features may not be required for all implementations. In some examples, the procedure 1400 may be carried out by the scheduled entity 1800 illustrated in FIG. 18. In some examples, the process 1400 may be carried out by any suitable apparatus or means for carrying out the functions or algorithm described below.

As described above, a scheduled entity (e.g., UE 902) can use a time gap (e.g., time gap 1110) on an active USIM (e.g., a first USIM in an RRC connected state) to perform certain network activities for a non-active USIM (e.g., a second USIM in an RRC idle/inactive state). During the time gap, the UE can perform an LBT procedure (e.g., NR-U LBT procedure) on the active USIM. For example, the timers and/or counters used for LBT can continue at the upper layers (e.g., MAC layer) while the UE can use the PHY layer (e.g., transceiver) for performing the network activities (e.g., monitoring and receiving page messages, receiving SIBs, performing idle mode measurements, etc.) on the non-active USIM.

In a network using unlicensed spectrum (e.g., NR-U), the UE can use an LBT procedure for channel access. The UE can first sense the communication channel to determine that there is no other wireless device(s) using the channel prior to any transmission. In the LBT procedure, the UE can sense the communication channel to detect the energy or signal level on one or more sub-bands of the communication channel. A communication channel is not available when the detected energy level is above a predetermined threshold (e.g., a signal strength or quality threshold). An LBT failure occurs when the UE fails to find a clear channel for channel access or transmission, for example, within a predetermined time. The UE can use one or more LBT timers to keep track of the time during the LBT procedure.

At decision block 1402, the UE can determine whether an LBT failure occurs on an SCell that is associated with the active USIM. At block 1404, if an LBT failure occurred on the SCell, the UE can transmit an LBT failure indication after the time gap (e.g., time gap 1110) is terminated. For example, the UE can transmit the LBT failure indication in a MAC CE destined to the network associated with the active USIM. At decision block 1406, the UE can determine whether an LBT failure occurs on a PSCell that is associated with the active USIM. At block 1408, if an LB T failure occurred on the PSCell, the UE can transmit SCG failure information after the time gap is terminated. In one example, the UE can send the SCG failure information using RRC signaling to the network associated with the active USIM (e.g., first USIM). At decision block 1410, the UE can determine whether an LBT failure occurs on a PCell that is associated with the active USIM. At block 1412, if an LBT failure occurred on the PCell, the UE can switch BWP or initiate a RACH procedure after the time gap is terminated.

In some aspects, a scheduled entity (e.g., UE 902) may perform the procedures described in relation to FIGS. 11-14 in various orders and/or different combinations including all or some of the procedures. In one aspect, if a radio link failure (RLF), a beam failure, or an LBT failure occurs in a PSCell before the occurrence of an RLF in a PCell, and the UE does not have an opportunity to perform any corrective action as described above in FIGS. 11-14, the UE may perform the corrective action (e.g., sending SCG failure information or BFD MAC CE) after the time gap (e.g., time gap 1110) is terminated.

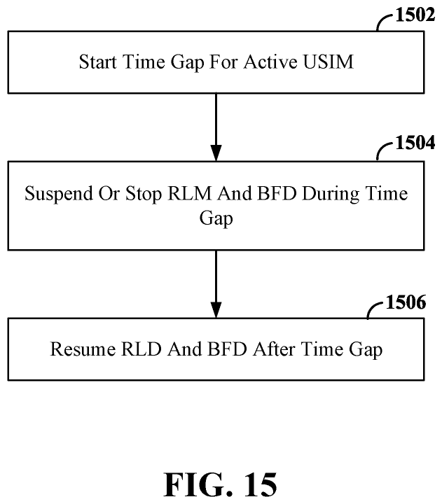

FIG. 15 is a flow chart illustrating a procedure 1500 for suspending or stopping RLM and BFD operations during a time gap on an active USIM at a MSIM wireless communication device according to some aspects. As described below, some or all illustrated features may be omitted in a particular implementation within the scope of the present disclosure, and some illustrated features may not be required for all implementations. In some examples, the procedure 1500 may be carried out by the scheduled entity 1800 illustrated in FIG. 18. In some examples, the process 1500 may be carried out by any suitable apparatus or means for carrying out the functions or algorithm described below.

At block 1502, a scheduled entity (e.g., UE 902) can start a time gap (e.g., time gap 1110) on an active USIM (e.g., a first USIM in RRC connected state) or its associated network to perform certain network activities on a non-active USIM (e.g., a second USIM in RRC idle/inactive state). At block 1504, during the time gap, the UE can stop or suspend BFD and/or RLM on the network associated with the active USIM. In one example, the UE can stop or reset the timers and/or counters used for RLM and/or BFD in the network associated with the active USIM during the time gap. For example, the UE does not perform RLM and/or BFD during the time gap at the upper layers (e.g., MAC layer or higher layers). In some aspects, the UE's PHY layer may provide measurements related to RLM and/or BFD to the upper layer (e.g., MAC layer) during the time gap. In some aspects, the PHY layer of the UE is aware of the time gap and can provide predetermined measurements (e.g., invalid values) related to RLM and/or BFD to the upper layers during the time gap. In this case, the upper layer can ignore these measurements while RLM and/or BFD operations are stopped or suspended during the time gap. At block 1506, the UE can resume RLM and/or BFD operations after the time gap is terminated, for example, at the configured expiration time or terminated by the UE before the expiration time.

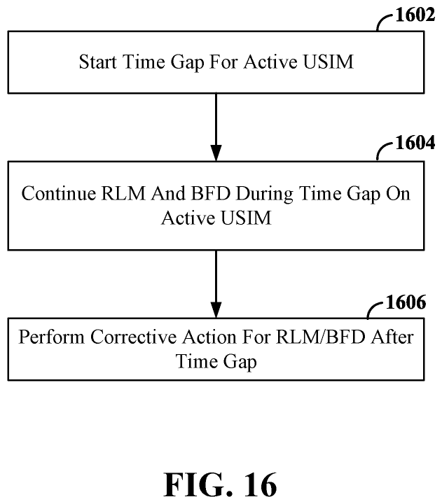

FIG. 16 is a flow chart illustrating a procedure 1600 for performing RLM and BFD operations during a time gap on an active USIM at a MSIM wireless communication device according to some aspects. As described below, some or all illustrated features may be omitted in a particular implementation within the scope of the present disclosure, and some illustrated features may not be required for all implementations. In some examples, the procedure 1600 may be carried out by the scheduled entity 1800 illustrated in FIG. 18. In some examples, the process 1600 may be carried out by any suitable apparatus or means for carrying out the functions or algorithm described below.

At block 1602, a scheduled entity (e.g., UE 902) can start a time gap (e.g., time gap 1110) on an active USIM (e.g., a first USIM in RRC connected state) or its associated network to perform certain network activities on a non-active USIM (e.g., a second USIM in RRC idle/inactive state).

At block 1604, the UE can continue RLM and BFD operations in the network associated with the active USIM during the time gap, but the UE does not take any corrective action (e.g., cell re-establishment or BFR) for a radio link failure or beam failure. At block 1606, the UE can perform the corrective action for RLM/BFD, if needed, after the time gap is terminated, for example, at the configured expiration time or terminated by the UE before the expiration time.

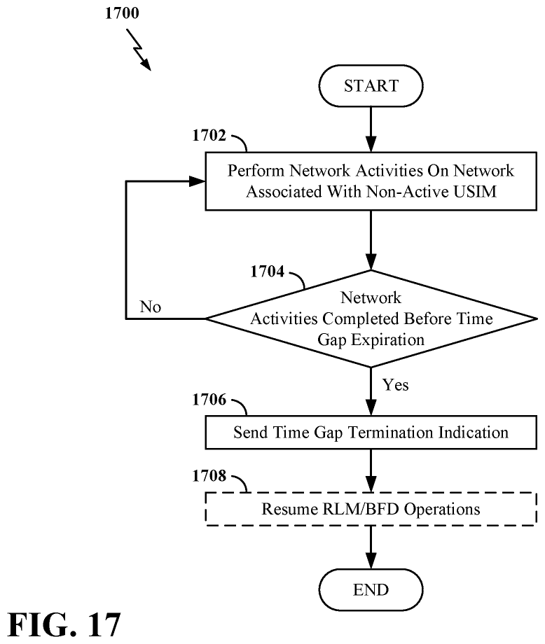

FIG. 17 is a flow chart illustrating a procedure 1700 for terminating a time gap on an active USIM at a MSIM wireless communication device according to some aspects. As described below, some or all illustrated features may be omitted in a particular implementation within the scope of the present disclosure, and some illustrated features may not be required for all implementations. In some examples, the procedure 1700 may be carried out by the scheduled entity 1800 illustrated in FIG. 18. In some examples, the process 1700 may be carried out by any suitable apparatus or means for carrying out the functions or algorithm described below.

At block 1702, a scheduled entity (e.g., UE 902) can perform network activities (e.g., monitoring and receiving page messages, receiving SIBs, performing idle mode measurements, etc.) on a non-active USIM in a time gap (e.g., time gap 1110) configured on an active USIM as described above.

At decision block 1704, the scheduled entity can determine whether or not the UE has finished the network activities in the network associated with the non-active USIM before the time gap expires. At block 1706, if the scheduled entity can finish the network activities (e.g., monitoring and receiving page messages, receiving SIBs, performing idle mode measurements, etc.) on the non-active USIM before the time gap expiration time as configured by the network entity, the UE can send a time gap termination indication (e.g., gap termination indication 1016) to the network (e.g., a base station, gNB) of the active USIM. In one example, the gap termination indication may be a scheduling request (SR) if the UE has UL data for transmission. In another example, the gap termination indication may be a special SR that is specifically used for indicating time gap termination. The UE can send the special SR even when the UE has no UL data pending for transmission. In another example, the gap termination indication may be a CSI report or HARQ feedback. The network (e.g., a base station, gNB) may transmit a confirmation to the UE in response to the gap termination indication.

At 1708, when the scheduled entity terminates the time gap early, the scheduled entity can resume RLM and/or BFD operations if stopped or suspended if no failure has happened during the time gap. If RLM/BFD is suspended during the time gap, the scheduled entity can resume the counters or timers used for RLM/BFD. If RLM/BFD is stopped during the time gap, the scheduled entity can restart the counters or timers used for RLM/BFD. In one example, the scheduled entity can resume RLM/BFD immediately when the scheduled entity resumes normal operations (no time gap) on the active USIM. In one example, the scheduled entity can resume RLM/BFD after sending a gap termination indication to the network entity (e.g., gNB) of the active USIM. In one example, the scheduled entity can resume RLM/BFD after receiving a termination confirmation from the network entity for the gap termination indications. For example, the termination confirmation may be an UL grant or any DL transmission from the network entity.

FIG. 18 is a block diagram illustrating an example of a hardware implementation for a scheduled entity 1800 employing a processing system 1814. For example, the scheduled entity 1800 may be a user equipment (UE) as illustrated in any one or more of FIGS. 1-3, 5-7, and 9-11.

The scheduled entity 1800 may be implemented with a processing system 1814 that includes one or more processors 1804. Examples of processors 1804 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduled entity 1800 may be configured to perform any one or more of the functions described herein. That is, the processor 1804, as utilized in a scheduled entity 1800, may be used to implement any one or more of the processes and procedures described herein and illustrated in, for example, FIGS. 9-17 and 19.

The processor 1804 may in some instances be implemented via a baseband or modem chip and in other implementations, the processor 1804 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1814 may be implemented with a bus architecture, represented generally by the bus 1802. The bus 1802 may include any number of interconnecting buses and bridges depending on the specific application of the processing system 1814 and the overall design constraints. The bus 1802 communicatively couples together various circuits including one or more processors (represented generally by the processor 1804), a memory 1805, and computer-readable media (represented generally by the computer-readable medium 1806). The bus 1802 may also link various other circuits such as timing sources, peripherals, voltage regulators, and power management circuits, which are well known in the art, and therefore, will not be described any further.

A bus interface 1808 provides an interface between the bus 1802 and a transceiver 1810, and one or more USIMs 1820 and 1822 (e.g., physical USIM cards and/or embedded USIMs). The transceiver 1810 provides a communication interface or means for communicating with various other apparatus over a transmission medium (e.g., air interface). The USIMs may include, for example, a first USIM (USIM 1) 1820 and a second USIM (USIM 2) 1822. Depending upon the nature of the apparatus, a user interface 1812 (e.g., keypad, display, speaker, microphone, joystick, touchscreen) may also be provided. Of course, such a user interface 1812 is optional, and may be omitted in some examples.

The processor 1804 is responsible for managing the bus 1802 and general processing, including the execution of software stored on the computer-readable medium 1806. The software, when executed by the processor 1804, causes the processing system 1814 to perform the various functions described below for any particular apparatus. The computer-readable medium 1806 and the memory 1805 may also be used for storing data that is manipulated by the processor 1804 when executing software.

One or more processors 1804 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1806. The computer-readable medium 1806 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1806 may reside in the processing system 1814, external to the processing system 1814, or distributed across multiple entities including the processing system 1814. The computer-readable medium 1806 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, the processor 1804 may include circuitry configured for various functions, including, for example, link and beam failure detection and monitoring using a time gap on an active USIM (e.g., first USIM 1820 in an RRC connected state) while performing network activities on a non-active SIM (e.g., second USIM 1822 in an RRC inactive/idle state). For example, the circuitry may be configured to implement one or more of the functions described in relation to FIGS. 9-17 and 19.

In some aspects of the disclosure, the processor 1804 may include communication and processing circuitry 1840 configured for various functions, including for example communicating with a network entity (e.g., scheduled entities, base stations, gNBs, CU/RUs). In some examples, the communication and processing circuitry 1840 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1840 may include one or more transmit/receive chains. In addition, the communication and processing circuitry 1840 may be configured to transmit and process uplink traffic and uplink control messages (e.g., similar to uplink traffic 116 and uplink control 118 of FIG. 1), receive and process downlink traffic and downlink control messages (e.g., similar to downlink traffic 112 and downlink control 114). The communication and processing circuitry 1840 may further be configured to execute communication and processing software 1850 stored on the computer-readable medium 1806 to implement one or more functions described herein.

In some implementations where the communication involves receiving information, the communication and processing circuitry 1840 may obtain information from a component of the scheduled entity 1800 (e.g., from the transceiver 1810 that receives the information via radio frequency signaling or some other type of signaling suitable for the applicable communication medium), process (e.g., decode) the information, and output the processed information. For example, the communication and processing circuitry 1840 may output the information to another component of the processor 1804, to the memory 1805, or to the bus interface 1808. In some examples, the communication and processing circuitry 1840 may receive one or more of signals, messages, other information, or any combination thereof. In some examples, the communication and processing circuitry 1840 may receive information via one or more channels. In some examples, the communication and processing circuitry 1840 may include functionality for a means for receiving. In some examples, the communication and processing circuitry 1840 may include functionality for a means for processing, including a means for demodulating, a means for decoding, etc.

In some implementations where the communication involves sending (e.g., transmitting) information, the communication and processing circuitry 1840 may obtain information (e.g., from another component of the processor 1804, the memory 1805, the USIM 1820 and 1822, or the bus interface 1808), process (e.g., modulate, encode, etc.) the information, and output the processed information. For example, the communication and processing circuitry 1840 may output the information to the transceiver 1810 (e.g., that transmits the information via radio frequency signaling or some other type of signaling suitable for the applicable communication medium). In some examples, the communication and processing circuitry 1840 may send one or more of signals, messages, other information, or any combination thereof. In some examples, the communication and processing circuitry 1840 may send information via one or more channels. In some examples, the communication and processing circuitry 1840 may include functionality for a means for sending (e.g., a means for transmitting). In some examples, the communication and processing circuitry 1840 may include functionality for a means for generating, including a means for modulating, a means for encoding, etc.

In some aspects of the disclosure, the processor 1804 may include link failure detection (LFD) circuitry 1842 configured for various functions, including for example radio link failure, beam failure, and LBT failure related functions and operations. The LFD circuitry 1842 may be configured to use one or more timers or counters (e.g., timers 1824) to monitor link failure, beam failure, and/or LBT failure on an active SIM (e.g., a USIM in an RRC connected state) while performing network activities on a non-active USIM (e.g., a USIM in an RRC idle/inactive state). In some aspects, the LFD circuitry 1842 may stop or suspend the timers or counters associated with link failure, beam failure, and/or LBT failure operations while the scheduled entity continues the link failure, beam failure, and/or LBT failure related operations at the upper layers (e.g., MAC layer or high layers) associated with the active USIM in a time gap, where the scheduled entity can perform network activities (e.g., monitoring and receiving page messages, receiving SIBs, performing idle mode measurements, etc.) for the non-active USIM. In some aspects, the LFD circuitry 1842 may be configured to transmit a request to a network entity (e.g., a base station, gNB, CU/RU) to configure the time gap. In some aspects, the LFD circuitry 1842 may be configured to terminate the time gap before it expires as configured by the network entity. The LFD circuitry 1842 may further be configured to execute link failure detection software 1852 stored on the computer-readable medium 1806 to implement one or more functions described herein.

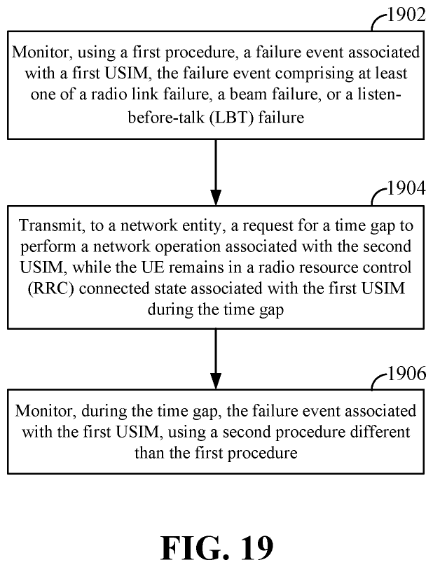

FIG. 19 is a flow chart illustrating an exemplary process 1900 for monitoring link failure at a multi-USIM wireless communication device in accordance with some aspects of the present disclosure. As described below, some or all illustrated features may be omitted in a particular implementation within the scope of the present disclosure, and some illustrated features may not be required for all implementations. In some examples, the process 1900 may be carried out by the network entity 1800 illustrated in FIG. 18. In some examples, the process 1900 may be carried out by any suitable apparatus or means for carrying out the functions or algorithm described below.

At block 1902, the network entity (e.g., UE) can monitor, using a first procedure, a failure event associated with a first USIM. The failure event can include at least one of a radio link failure, a beam failure, or a listen-before-talk (LBT) failure. In one example, the link failure detection circuitry 1842 can provide a mean to monitor the radio link failure, beam failure, or LBT failure associated with the first USIM (e.g., first USIM 1820 in an RRC connected state). The first procedure may be a procedure for monitoring, detecting, and/or recovering from a radio link failure, a beam failure, or an LBT failure when no time gap is configured. The first procedure may use certain timers and/or counters (e.g., timers 1824) and the UE's PHY layer for monitoring and detecting a link failure, a beam failure, or a LBT failure.

At block 1904, the network entity can transmit, to a network entity, a request for a time gap to perform a network operation associated with a second USIM, while the UE remains in an RRC connected state associated the first USIM during the time gap. In one example, the communication and processing circuitry 1840 can provide a means to transmit the request to the network entity (e.g., gNB) via the transceiver 1810. The network entity belongs to a network associated with the first USIM. In one example, the network entity can receive a time gap configuration from the scheduling entity, and configure the time gap based on the time gap configuration. The network entity can configure one or more time gaps in which the network entity can perform the network operation (e.g., monitoring and receiving page messages, receiving SIBs, performing idle mode measurements, etc.) on the second USIM that is in a non-active state (e.g., RRC idle/inactive state).

At block 1906, the network entity can monitor, during the time gap, the failure event associated with the first USIM, using a second different than the first procedure. In one example, the link failure detection circuitry 1842 can provide a mean to monitor the failure event (e.g., radio link failure, beam failure, or LBT failure) using the second procedure. In the second procedure, the network entity may continue to perform the procedures for radio link failure, beam failure, or LBT failure at upper network layers (e.g., MAC layer) but the network entity can use the PHY layer to perform the network operation associated with the second USIM. In one example, the second procedure may include the procedure 1100 (described above in relation to FIG. 11) that can be used to monitor the occurrence of a beam failure during a time gap on the active SIM. In one example, the second procedure may include the procedure 1200 (described above in relation to FIG. 12) that can be used to monitor the occurrence of a radio link failure during a time gap on the active SIM. In one example, the second procedure may include the procedure 1300 (described above in relation to FIG. 13) that can be used to monitor the occurrence of a LBT failure during a time gap on the active SIM.

In one configuration, the aforementioned means may be the processor 1804 and/or one or more other circuitry and components included in the network entity shown in FIG. 18 that can be configured to perform the functions recited by the aforementioned means. In another aspect, the aforementioned means may be a circuit or any apparatus configured to perform the functions recited by the aforementioned means.

Of course, in the above examples, the circuitry included in the processor 1804 is merely provided as an example, and other means for carrying out the described functions may be included within various aspects of the present disclosure, including but not limited to the instructions stored in the computer-readable storage medium 1806, or any other suitable apparatus or means described in any one of the FIGS. 1-3, 5-7, and/or 9-11, and, and utilizing, for example, the processes and/or algorithms described herein in relation to FIGS. 8-17.

A first aspect provides user equipment (UE) in a wireless communication network, comprising: a transceiver; a memory; a first universal subscriber identity module (USIM); a second USIM; and a processor coupled to the first USIM, the second USIM, the transceiver, and the memory, wherein the processor and the memory are configured to: monitor, using a first procedure, a failure event associated with the first USIM, the failure event comprising at least one of a radio link failure, a beam failure, or a listen-before-talk (LBT) failure; transmit, to a scheduling entity, a request for a time gap to perform a network operation associated with the second USIM, while the first USIM remains in a radio resource control (RRC) connected state during the time gap; and monitor, using a second procedure during the time gap, the failure event associated with the first USIM.

In a second aspect, alone or in combination with the first aspect, wherein the processor and the memory are further configured to: perform the network operation associated with the second USIM in the time gap, while the second USIM is in an RRC idle state or RRC inactive state; and transmit, to the scheduling entity, a signal configured to indicate completion of the network operation associated with the second USIM before the time gap expires.

In a third aspect, alone or in combination with the second aspect, wherein the signal comprises a scheduling request, a channel state information feedback, or a hybrid automatic repeat request feedback.

In a fourth aspect, alone or in combination with any of the second to third aspects, wherein the processor and the memory are further configured to, at least one of: resume monitoring the failure event using the first procedure after performing the network operation associated with the second USIM; resume monitoring the failure event using the first procedure after transmitting the signal configured to indicate completion of the network operation associated with the second USIM; or resume monitoring the failure event using the first procedure after receiving a confirmation from the scheduling entity for the signal configured to indicate completion of the network operation associated with the second USIM.

In a fifth aspect, alone or in combination with any of the first to third aspects, wherein, in the second procedure, the processor and the memory are further configured to, at least one of: transmit secondary cell group (SCG) failure information after the time gap terminates due to expiration of the time gap or early termination by the UE, in response to determining that the radio link failure occurs on a primary SCG cell (PSCell) associated with the first USIM; or perform cell selection and re-establishment after the time gap terminates due to expiration of the time gap or early termination by the UE, in response to determining that the radio link failure occurs on a primary serving cell (PCell) associated with the first USIM.

In a sixth aspect, alone or in combination with any of the first to third aspects, wherein, in the second procedure, the processor and the memory are further configured to, at least one of: transmit a beam failure indication after the time gap terminates due to expiration of the time gap or early termination by the UE, in response to determining that the beam failure occurs on a secondary serving cell (SCell) associated with the first USIM; or perform beam failure recovery after the time gap terminates due to expiration of the time gap or early termination by the UE, in response to determining that the beam failure occurs on a primary serving cell (PCell) or a primary secondary cell group cell (PSCell) associated with the first USIM.

In a seventh aspect, alone or in combination with any of the first to third aspects, wherein, in the second procedure, the processor and the memory are further configured to, at least one of: transmit a LBT failure indication after the time gap terminates due to expiration of the time gap or early termination by the UE, in response to determining that the LBT failure occurs on a secondary serving cell (SCell) associated with the first USIM; transmit secondary cell group (SCG) failure information after the time gap terminates due to expiration of the time gap or early termination by the UE, in response to determining that the LBT failure occurs on a primary SCG cell (PSCell) associated with the first USIM; or change a bandwidth part or initiate a random access procedure after the time gap terminates due to expiration of the time gap or early termination by the UE, in response to determining that the LBT failure occurs on a primary service cell (PCell) associated with the first USIM.

In an eighth aspect, alone or in combination with any of the first to third aspects, wherein, in the second procedure, the processor and the memory are further configured to, at least one of: transmit secondary cell group (SCG) failure information after the time gap terminates due to expiration of the time gap or early termination by the UE, in response to determining that the radio link failure, beam failure, or LBT failure occurs on a primary SCG cell (PSCell) before the radio link failure occurs on the primary serving cell (PCell).

In a ninth aspect, alone or in combination with any of the first to third aspects, wherein, in the second procedure, the processor and the memory are further configured to suspend or stop monitoring the failure event.

In a tenth aspect, alone or in combination with the ninth aspect, wherein, in the second procedure, the processor and the memory are further configured to, at least one of: stop a timer or a counter configured to monitor the radio link failure; reset a timer or a counter configured to monitor the beam failure; or stop monitoring the radio link failure and beam failure.

In an eleventh aspect, alone or in combination with any of the first to third aspects, wherein, in the second procedure, the processor and the memory are further configured to: forgo corrective action in response to detection of the radio link failure, the beam failure, or the LBT failure.

A twelfth aspect provides a method of wireless communication at a user equipment (UE), the method comprising: monitoring, using a first procedure, a failure event associated with a first universal subscriber identity module (USIM) of the UE, the failure event comprising at least one of a radio link failure, a beam failure, or a listen-before-talk (LBT) failure; transmitting, to a scheduling entity, a request for a time gap to perform a network operation associated with a second USIM of the UE, while the first USIM remains in a radio resource control (RRC) connected state during the time gap; and monitoring, using a second procedure during the time gap, the failure event associated with the first USIM.

In a thirteenth aspect, alone or in combination with the twelfth aspect, the method further comprises: performing the network operation associated with the second USIM in the time gap, while the second USIM is in an RRC idle state or RRC inactive state; and transmitting, to the scheduling entity, a signal configured to indicate completion of the network operation associated with the second USIM before the time gap expires.

In a fourteenth aspect, alone or in combination with the thirteenth aspect, wherein the signal comprises a scheduling request, a channel state information feedback, or a hybrid automatic repeat request feedback.

In a fifteenth aspect, alone or in combination with any of the thirteenth to fourteenth aspects, the method further comprises, at least one of: resuming monitoring the failure event using the first procedure after performing the network operation associated with the second USIM; resuming monitoring the failure event using the first procedure after transmitting the signal configured to indicate completion of the network operation associated with the second USIM; or resuming monitoring the failure event using the first procedure after receiving a confirmation from the scheduling entity for the signal configured to indicate completion of the network operation associated with the second USIM.

In a sixteenth aspect, alone or in combination with any of the twelfth to fourteenth aspects, wherein the second procedure comprises at least one of: transmitting secondary cell group (SCG) failure information after the time gap terminates due to expiration of the time gap or early termination by the UE, in response to determining that the radio link failure occurs on a primary SCG cell (PSCell) associated with the first USIM; or performing cell selection and re-establishment after the time gap terminates due to expiration of the time gap or early termination by the UE, in response to determining that the radio link failure occurs on a primary serving cell (PCell) associated with the first USIM.

In a seventeenth aspect, alone or in combination with any of the twelfth to fourteenth aspects, wherein the second procedure comprises at least one of: transmitting a beam failure indication after the time gap terminates due to expiration of the time gap or early termination by the UE, in response to determining that the beam failure occurs on a secondary serving cell (SCell) associated with the first USIM; or performing beam failure recovery after the time gap terminates due to expiration of the time gap or early termination by the UE, in response to determining that the beam failure occurs on a primary serving cell (PCell) or a primary secondary cell group cell (PSCell) associated with the first USIM.

In an eighteenth aspect, alone or in combination with any of the twelfth to fourteenth aspects, wherein the second procedure comprises at least one of: transmitting a LBT failure indication after the time gap terminates due to expiration of the time gap or early termination by the UE, in response to determining that the LBT failure occurs on a secondary serving cell (SCell) associated with the first USIM; transmitting secondary cell group (SCG) failure information after the time gap terminates due to expiration of the time gap or early termination by the UE, in response to determining that the LBT failure occurs on a primary SCG cell (PSCell) associated with the first USIM; or changing a bandwidth part or initiating a random access procedure after the time gap terminates due to expiration of the time gap or early termination by the UE, in response to determining that the LBT failure occurs on a primary service cell (PCell) associated with the first USIM.

In a nineteenth aspect, alone or in combination with any of the twelfth to fourteenth aspects, wherein the second procedure comprises at least one of: transmitting secondary cell group (SCG) failure information after the time gap terminates due to expiration of the time gap or early termination by the UE, in response to determining that the radio link failure, beam failure, or LBT failure occurs on a primary SCG cell (PSCell) before the radio link failure occurs on the primary serving cell (PCell).

In a twentieth aspect, alone or in combination with any of the twelfth to fourteenth aspects, wherein the second procedure comprises suspending or stopping the monitoring of the failure event.

In a twenty-first aspect, alone or in combination with the twentieth aspect, wherein the second procedure further comprises at least one of: stopping a timer or a counter configured to monitor the radio link failure; resetting a timer or a counter configured to monitor the beam failure; or stopping the monitoring of the radio link failure and beam failure.

In a twenty-second aspect, alone or in combination with any of the twelfth to fourteenth aspects, wherein the second procedure comprises: forgoing corrective action in response to detection of the radio link failure, the beam failure, or the LBT failure.

In a twenty-third aspect, a user equipment (UE) in a wireless communication network is provided. The UE comprises: a memory; a first universal subscriber identity module (USIM); a second USIM; and a processor coupled to the first USIM, the second USIM, and the memory, the processor being configured to: monitor, using a first procedure, a failure event associated with the first USIM, the failure event comprising at least one of a radio link failure (RLF), a beam failure, or a listen-before-talk (LBT) failure; transmit, to a network entity, a request for a time gap to perform a network operation associated with the second USIM, while the UE remains in a radio resource control (RRC) connected state associated with the first USIM during the time gap; and monitor, during the time gap, the failure event associated with the first USIM, using a second procedure different than the first procedure.

In a twenty-fourth aspect, alone or in combination with the twenty-third aspect, wherein the processor is further configured to: perform the network operation associated with the second USIM during the time gap, while the second USIM remains in an RRC idle state or an RRC inactive state; and transmit, to the network entity, a signal configured to indicate completion of the network operation associated with the second USIM before the time gap expires.

In a twenty-fifth aspect, alone or in combination with the twenty-fourth aspect, wherein the signal comprises a scheduling request, a channel state information feedback, or a hybrid automatic repeat request feedback.

In a twenty-sixth aspect, alone or in combination with the twenty-third aspect, wherein the processor is further configured to, at least one of: resume monitoring the failure event using the first procedure after performing the network operation associated with the second USIM; resume monitoring the failure event using the first procedure after transmitting the signal configured to indicate completion of the network operation associated with the second USIM; or resume monitoring the failure event using the first procedure after receiving a confirmation from the network entity for the signal configured to indicate completion of the network operation associated with the second USIM.

In a twenty-seventh aspect, alone or in combination with any of the twenty-third to twenty-sixth aspects, wherein, in the second procedure, the processor is further configured to, at least one of: transmit secondary cell group (SCG) failure information after the time gap terminates due to expiration of the time gap or early termination effected by the UE, in response to determining that the RLF occurs on a primary SCG cell (PSCell) associated with the first USIM; or perform cell selection and re-establishment after the time gap terminates due to expiration of the time gap or early termination effected by the UE, in response to determining that the RLF occurs on a primary serving cell (PCell) associated with the first USIM.

In a twenty-eighth aspect, alone or in combination with any of the twenty-third to twenty-sixth aspects, wherein, in the second procedure, the processor is further configured to, at least one of: transmit a beam failure indication after the time gap terminates due to expiration of the time gap or early termination effected by the UE, in response to determining that the beam failure occurs on a secondary serving cell (SCell) associated with the first USIM; or perform beam failure recovery after the time gap terminates due to expiration of the time gap or early termination effected by the UE, in response to determining that the beam failure occurs on a primary serving cell (PCell) or a primary secondary cell group cell (PSCell) associated with the first USIM.

In a twenty-ninth aspect, alone or in combination with any of the twenty-third to twenty-sixth aspects, wherein, in the second procedure, the processor is further configured to, at least one of: transmit a LBT failure indication after the time gap terminates due to expiration of the time gap or early termination effected by the UE, in response to determining that the LBT failure occurs on a secondary serving cell (SCell) associated with the first USIM; transmit secondary cell group (SCG) failure information after the time gap terminates due to expiration of the time gap or early termination effected by the UE, in response to determining that the LBT failure occurs on a primary SCG cell (PSCell) associated with the first USIM; or change a bandwidth part or initiate a random access procedure after the time gap terminates due to expiration of the time gap or early termination effected by the UE, in response to determining that the LBT failure occurs on a primary service cell (PCell) associated with the first USIM.

In a thirtieth aspect, alone or in combination with any of the twenty-third to twenty-sixth aspects, wherein, in the second procedure, the processor is further configured to, at least one of: transmit secondary cell group (SCG) failure information after the time gap terminates due to expiration of the time gap or early termination effected by the UE, in response to determining that the RLF, beam failure, or LBT failure occurs on a primary SCG cell (PSCell) before the RLF occurs on a primary serving cell (PCell).

In a thirty-first aspect, alone or in combination with any of the twenty-third to twenty-sixth aspects, wherein, in the second procedure, the processor is further configured to suspend or stop monitoring the failure event.

In a thirty-second aspect, alone or in combination with any of the twenty-third to twenty-sixth aspects, wherein, in the second procedure, the processor is further configured to, at least one of: stop a timer or a counter configured to monitor the RLF; reset a timer or a counter configured to monitor the beam failure; or stop monitoring the RLF and beam failure.

In a thirty-third aspect, alone or in combination with any of the twenty-third to twenty-sixth aspects, wherein, in the second procedure, the processor is further configured to: forgo corrective action in response to detection of the RLF, the beam failure, or the LBT failure.

In a thirty-fourth aspect, a method of wireless communication at a user equipment (UE) is provided. The method comprises: monitoring, using a first procedure, a failure event associated with a first universal subscriber identity module (USIM) of the UE, the failure event comprising at least one of a radio link failure (RLF), a beam failure, or a listen-before-talk (LBT) failure; transmitting, to a network entity, a request for a time gap to perform a network operation associated with a second USIM of the UE, while the UE remains in a radio resource control (RRC) connected state associated with the first USIM during the time gap; and monitoring, using a second procedure during the time gap, the failure event associated with the first USIM, the first procedure and the second procedure being different in techniques used for monitoring to at least one of the RLF, the beam failure, or the LBT failure.

In a thirty-fifth aspect, alone or in combination with the thirty-fourth aspect, the method further comprises: performing the network operation associated with the second USIM during the time gap, while the second USIM remains in an RRC idle state or an RRC inactive state; and transmitting, to the network entity, a signal configured to indicate completion of the network operation associated with the second USIM before the time gap expires.

In a thirty-sixth aspect, alone or in combination with the thirty-fifth aspect, wherein the signal comprises a scheduling request, a channel state information feedback, or a hybrid automatic repeat request feedback.

In a thirty-seventh aspect, alone or in combination with the thirty-fifth aspect, the method further comprises, at least one of: resuming monitoring the failure event using the first procedure after performing the network operation associated with the second USIM; resuming monitoring the failure event using the first procedure after transmitting the signal configured to indicate completion of the network operation associated with the second USIM; or resuming monitoring the failure event using the first procedure after receiving a confirmation from the network entity for the signal configured to indicate completion of the network operation associated with the second USIM.

In a thirty-eighth aspect, alone or in combination with any of the thirty-fourth to thirty-seventh aspects, wherein the second procedure comprises at least one of: transmitting secondary cell group (SCG) failure information after the time gap terminates due to expiration of the time gap or early termination effected by the UE, in response to determining that the RLF occurs on a primary SCG cell (PSCell) associated with the first USIM; or performing cell selection and re-establishment after the time gap terminates due to expiration of the time gap or early termination effected by the UE, in response to determining that the RLF occurs on a primary serving cell (PCell) associated with the first USIM.

In a thirty-ninth aspect, alone or in combination with any of the thirty-fourth to thirty-seventh aspects, wherein the second procedure comprises at least one of: transmitting a beam failure indication after the time gap terminates due to expiration of the time gap or early termination effected by the UE, in response to determining that the beam failure occurs on a secondary serving cell (SCell) associated with the first USIM; or performing beam failure recovery after the time gap terminates due to expiration of the time gap or early termination effected by the UE, in response to determining that the beam failure occurs on a primary serving cell (PCell) or a primary secondary cell group cell (PSCell) associated with the first USIM.

In a fortieth aspect, alone or in combination with any of the thirty-fourth to thirty-seventh aspects, wherein the second procedure comprises at least one of: transmitting a LBT failure indication after the time gap terminates due to expiration of the time gap or early termination effected by the UE, in response to determining that the LBT failure occurs on a secondary serving cell (SCell) associated with the first USIM; transmitting secondary cell group (SCG) failure information after the time gap terminates due to expiration of the time gap or early termination effected by the UE, in response to determining that the LBT failure occurs on a primary SCG cell (PSCell) associated with the first USIM; or changing a bandwidth part or initiating a random access procedure after the time gap terminates due to expiration of the time gap or early termination effected by the UE, in response to determining that the LBT failure occurs on a primary service cell (PCell) associated with the first USIM.

In a forty-first aspect, alone or in combination with any of the thirty-fourth to thirty-seventh aspects, wherein the second procedure comprises at least one of: transmitting secondary cell group (SCG) failure information after the time gap terminates due to expiration of the time gap or early termination effected by the UE, in response to determining that the RLF, beam failure, or LBT failure occurs on a primary SCG cell (PSCell) before the RLF occurs on a primary serving cell (PCell).

In a forty-second aspect, alone or in combination with any of the thirty-fourth to thirty-seventh aspects, wherein the second procedure comprises suspending or stopping the monitoring of the failure event.

In a forty-third aspect, alone or in combination with any of the thirty-fourth to thirty-seventh aspects, wherein the second procedure further comprises at least one of: stopping a timer or a counter configured to monitor the RLF; resetting a timer or a counter configured to monitor the beam failure; or stopping the monitoring of the RLF and beam failure.

In a forty-fourth aspect, alone or in combination with any of the thirty-fourth to thirty-seventh aspects, wherein the second procedure comprises: forgoing corrective action in response to detection of the RLF, the beam failure, or the LBT failure.

In a forty-fifth aspect, a user equipment (UE) for wireless communication is provided. The UE comprises: means for monitoring, using a first procedure, a failure event associated with a first universal subscriber identity module (USIM) of the UE, the failure event comprising at least one of a radio link failure (RLF), a beam failure, or a listen-before-talk (LBT) failure; means for transmitting, to a network entity, a request for a time gap to perform a network operation associated with a second USIM of the UE, while the UE remains in a radio resource control (RRC) connected state associated with the first USIM during the time gap; and means for monitoring, during the time gap, the failure event associated with the first USIM, using a second procedure different than the first procedure.

In a forty-sixth aspect, alone or in combination with the forty-fifth aspect, the UE further comprises: mean for performing the network operation associated with the second USIM during the time gap, while the second USIM remains in an RRC idle state or an RRC inactive state; and means for transmitting, to the network entity, a signal configured to indicate completion of the network operation associated with the second USIM before the time gap expires.

In a forty-seventh aspect, alone or in combination with the forty-sixth aspect, wherein the signal comprises a scheduling request, a channel state information feedback, or a hybrid automatic repeat request feedback.

In a forty-eighth aspect, alone or in combination with the forty-sixth or forty-seventh aspect, the UE further comprises, at least one of: means for resuming monitoring the failure event using the first procedure after performing the network operation associated with the second USIM; means for resuming monitoring the failure event using the first procedure after transmitting the signal configured to indicate completion of the network operation associated with the second USIM; or means for resuming monitoring the failure event using the first procedure after receiving a confirmation from the network entity for the signal configured to indicate completion of the network operation associated with the second USIM.

In a forty-ninth aspect, a computer-readable storage medium stored with executable codes for wireless communication is provided. The executable codes comprises instructions that cause a user equipment (UE) to: monitor, using a first procedure, a failure event associated with a first universal subscriber identity module (USIM) of the UE, the failure event comprising at least one of a radio link failure (RLF), a beam failure, or a listen-before-talk (LBT) failure; transmit, to a network entity, a request for a time gap to perform a network operation associated with a second USIM of the UE, while the UE remains in a radio resource control (RRC) connected state associated with the first USIM during the time gap; and monitor, during the time gap, the failure event associated with the first USIM, using a second procedure different than the first procedure.

In a fiftieth aspect, alone or in combination with the forty-ninth aspect, wherein the executable codes further comprises instructions that cause the UE to: perform the network operation associated with the second USIM during the time gap, while the second USIM remains in an RRC idle state or an RRC inactive state; and transmit, to the network entity, a signal configured to indicate completion of the network operation associated with the second USIM before the time gap expires.

In a fifty-first aspect, alone or in combination with the fiftieth aspect, wherein the signal comprises a scheduling request, a channel state information feedback, or a hybrid automatic repeat request feedback.

In a fifty-second aspect, alone or in combination with the fiftieth or fifty-first aspect, wherein the executable codes further comprises instructions that cause the UE to at least one of: resume monitoring the failure event using the first procedure after performing the network operation associated with the second USIM; resume monitoring the failure event using the first procedure after transmitting the signal configured to indicate completion of the network operation associated with the second USIM; or resume monitoring the failure event using the first procedure after receiving a confirmation from the network entity for the signal configured to indicate completion of the network operation associated with the second USIM.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-19 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-19 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A user equipment (UE) in a wireless communication network, comprising:
a memory;
a first universal subscriber identity module (USIM);
a second USIM; and
a processor coupled to the first USIM, the second USIM, and the memory, the processor being configured to:
monitor, using a first procedure, a failure event associated with the first USIM, the failure event comprising at least one of a radio link failure (RLF), a beam failure, or a listen-before-talk (LBT) failure;
transmit, to a network entity, a request for a time gap to perform a network operation associated with the second USIM, while the UE remains in a radio resource control (RRC) connected state associated with the first USIM during the time gap; and
monitor, during the time gap, the failure event associated with the first USIM, using a second procedure different than the first procedure.

2. The UE of claim 1, wherein the processor is further configured to:
perform the network operation associated with the second USIM during the time gap, while the second USIM remains in an RRC idle state or an RRC inactive state; and
transmit, to the network entity, a signal configured to indicate completion of the network operation associated with the second USIM before the time gap expires.

3. The UE of claim 2, wherein the signal comprises a scheduling request, a channel state information feedback, or a hybrid automatic repeat request feedback.

4. The UE of claim 2, wherein the processor is further configured to, at least one of:
resume monitoring the failure event using the first procedure after performing the network operation associated with the second USIM;
resume monitoring the failure event using the first procedure after transmitting the signal configured to indicate completion of the network operation associated with the second USIM; or
resume monitoring the failure event using the first procedure after receiving a confirmation from the network entity for the signal configured to indicate completion of the network operation associated with the second USIM.

5. The UE of claim 1, wherein, in the second procedure, the processor is further configured to, at least one of:
transmit secondary cell group (SCG) failure information after the time gap terminates due to expiration of the time gap or early termination effected by the UE, in response to determining that the RLF occurs on a primary SCG cell (PSCell) associated with the first USIM; or
perform cell selection and re-establishment after the time gap terminates due to expiration of the time gap or early termination effected by the UE, in response to determining that the RLF occurs on a primary serving cell (PCell) associated with the first USIM.

6. The UE of claim 1, wherein, in the second procedure, the processor is further configured to, at least one of:
transmit a beam failure indication after the time gap terminates due to expiration of the time gap or early termination effected by the UE, in response to determining that the beam failure occurs on a secondary serving cell (SCell) associated with the first USIM; or
perform beam failure recovery after the time gap terminates due to expiration of the time gap or early termination effected by the UE, in response to determining that the beam failure occurs on a primary serving cell (PCell) or a primary secondary cell group cell (PSCell) associated with the first USIM.

7. The UE of claim 1, wherein, in the second procedure, the processor is further configured to, at least one of:
transmit a LBT failure indication after the time gap terminates due to expiration of the time gap or early termination effected by the UE, in response to determining that the LBT failure occurs on a secondary serving cell (SCell) associated with the first USIM;
transmit secondary cell group (SCG) failure information after the time gap terminates due to expiration of the time gap or early termination effected by the UE, in response to determining that the LBT failure occurs on a primary SCG cell (PSCell) associated with the first USIM; or
change a bandwidth part or initiate a random access procedure after the time gap terminates due to expiration of the time gap or early termination effected by the UE, in response to determining that the LBT failure occurs on a primary service cell (PCell) associated with the first USIM.

8. The UE of claim 1, wherein, in the second procedure, the processor is further configured to, at least one of:
transmit secondary cell group (SCG) failure information after the time gap terminates due to expiration of the time gap or early termination effected by the UE, in response to determining that the RLF, beam failure, or LBT failure occurs on a primary SCG cell (PSCell) before the RLF occurs on a primary serving cell (PCell).

9. The UE of claim 1, wherein, in the second procedure, the processor is further configured to suspend or stop monitoring the failure event.

10. The UE of claim 1, wherein, in the second procedure, the processor is further configured to, at least one of:
stop a timer or a counter configured to monitor the RLF;
reset a timer or a counter configured to monitor the beam failure; or
stop monitoring the RLF and beam failure.

11. The UE of claim 1, wherein, in the second procedure, the processor is further configured to:
forgo corrective action in response to detection of the RLF, the beam failure, or the LBT failure.

12. A method of wireless communication at a user equipment (UE), the method comprising:
monitoring, using a first procedure, a failure event associated with a first universal subscriber identity module (USIM) of the UE, the failure event comprising at least one of a radio link failure (RLF), a beam failure, or a listen-before-talk (LBT) failure;
transmitting, to a network entity, a request for a time gap to perform a network operation associated with a second USIM of the UE, while the UE remains in a radio resource control (RRC) connected state associated with the first USIM during the time gap; and
monitoring, using a second procedure during the time gap, the failure event associated with the first USIM, the first procedure and the second procedure being different in techniques used for monitoring to at least one of the RLF, the beam failure, or the LBT failure.

13. The method of claim 12, further comprising:
performing the network operation associated with the second USIM during the time gap, while the second USIM remains in an RRC idle state or an RRC inactive state; and
transmitting, to the network entity, a signal configured to indicate completion of the network operation associated with the second USIM before the time gap expires.

14. The method of claim 13, wherein the signal comprises a scheduling request, a channel state information feedback, or a hybrid automatic repeat request feedback.

15. The method of claim 13, further comprising, at least one of:
resuming monitoring the failure event using the first procedure after performing the network operation associated with the second USIM;
resuming monitoring the failure event using the first procedure after transmitting the signal configured to indicate completion of the network operation associated with the second USIM; or
resuming monitoring the failure event using the first procedure after receiving a confirmation from the network entity for the signal configured to indicate completion of the network operation associated with the second USIM.

16. The method of claim 12, wherein the second procedure comprises at least one of:
transmitting secondary cell group (SCG) failure information after the time gap terminates due to expiration of the time gap or early termination effected by the UE, in response to determining that the RLF occurs on a primary SCG cell (PSCell) associated with the first USIM; or
performing cell selection and re-establishment after the time gap terminates due to expiration of the time gap or early termination effected by the UE, in response to determining that the RLF occurs on a primary serving cell (PCell) associated with the first USIM.

17. The method of claim 12, wherein the second procedure comprises at least one of:
transmitting a beam failure indication after the time gap terminates due to expiration of the time gap or early termination effected by the UE, in response to determining that the beam failure occurs on a secondary serving cell (SCell) associated with the first USIM; or
performing beam failure recovery after the time gap terminates due to expiration of the time gap or early termination effected by the UE, in response to determining that the beam failure occurs on a primary serving cell (PCell) or a primary secondary cell group cell (PSCell) associated with the first USIM.

18. The method of claim 12, wherein the second procedure comprises at least one of:
transmitting a LBT failure indication after the time gap terminates due to expiration of the time gap or early termination effected by the UE, in response to determining that the LBT failure occurs on a secondary serving cell (SCell) associated with the first USIM;
transmitting secondary cell group (SCG) failure information after the time gap terminates due to expiration of the time gap or early termination effected by the UE, in response to determining that the LBT failure occurs on a primary SCG cell (PSCell) associated with the first USIM; or
changing a bandwidth part or initiating a random access procedure after the time gap terminates due to expiration of the time gap or early termination effected by the UE, in response to determining that the LBT failure occurs on a primary service cell (PCell) associated with the first USIM.

19. The method of claim 12, wherein the second procedure comprises at least one of:
transmitting secondary cell group (SCG) failure information after the time gap terminates due to expiration of the time gap or early termination effected by the UE, in response to determining that the RLF, beam failure, or LBT failure occurs on a primary SCG cell (PSCell) before the RLF occurs on a primary serving cell (PCell).

20. The method of claim 12, wherein the second procedure comprises suspending or stopping the monitoring of the failure event.

21. The method of claim 12, wherein the second procedure further comprises at least one of:
stopping a timer or a counter configured to monitor the RLF;
resetting a timer or a counter configured to monitor the beam failure; or
stopping the monitoring of the RLF and beam failure.

22. The method of claim 12, wherein the second procedure comprises:
forgoing corrective action in response to detection of the RLF, the beam failure, or the LBT failure.

23. A user equipment (UE) for wireless communication, comprising:
means for monitoring, using a first procedure, a failure event associated with a first universal subscriber identity module (USIM) of the UE, the failure event comprising at least one of a radio link failure (RLF), a beam failure, or a listen-before-talk (LBT) failure;
means for transmitting, to a network entity, a request for a time gap to perform a network operation associated with a second USIM of the UE, while the UE remains in a radio resource control (RRC) connected state associated with the first USIM during the time gap; and
means for monitoring, during the time gap, the failure event associated with the first USIM, using a second procedure different than the first procedure.

24. The UE of claim 23, further comprising:
mean for performing the network operation associated with the second USIM during the time gap, while the second USIM remains in an RRC idle state or an RRC inactive state; and
means for transmitting, to the network entity, a signal configured to indicate completion of the network operation associated with the second USIM before the time gap expires.

25. The UE of claim 24, wherein the signal comprises a scheduling request, a channel state information feedback, or a hybrid automatic repeat request feedback.

26. The UE of claim 24, further comprising, at least one of:
means for resuming monitoring the failure event using the first procedure after performing the network operation associated with the second USIM;
means for resuming monitoring the failure event using the first procedure after transmitting the signal configured to indicate completion of the network operation associated with the second USIM; or
means for resuming monitoring the failure event using the first procedure after receiving a confirmation from the network entity for the signal configured to indicate completion of the network operation associated with the second USIM.

27. A computer-readable storage medium stored with executable codes for wireless communication, the executable codes comprising instructions that cause a user equipment (UE) to:
monitor, using a first procedure, a failure event associated with a first universal subscriber identity module (USIM) of the UE, the failure event comprising at least one of a radio link failure (RLF), a beam failure, or a listen-before-talk (LBT) failure;
transmit, to a network entity, a request for a time gap to perform a network operation associated with a second USIM of the UE, while the UE remains in a radio resource control (RRC) connected state associated with the first USIM during the time gap; and
monitor, during the time gap, the failure event associated with the first USIM, using a second procedure different than the first procedure.

28. The computer-readable storage medium of claim 27, wherein the executable codes further comprises instructions that cause the UE to:
perform the network operation associated with the second USIM during the time gap, while the second USIM remains in an RRC idle state or an RRC inactive state; and
transmit, to the network entity, a signal configured to indicate completion of the network operation associated with the second USIM before the time gap expires.

29. The computer-readable storage medium of claim 28, wherein the signal comprises a scheduling request, a channel state information feedback, or a hybrid automatic repeat request feedback.

30. The computer-readable storage medium of claim 28, wherein the executable codes further comprises instructions that cause the UE to at least one of:
resume monitoring the failure event using the first procedure after performing the network operation associated with the second USIM;
resume monitoring the failure event using the first procedure after transmitting the signal configured to indicate completion of the network operation associated with the second USIM; or
resume monitoring the failure event using the first procedure after receiving a confirmation from the network entity for the signal configured to indicate completion of the network operation associated with the second USIM.
